(19) United States
(12) Patent Application Publication
(10) Pub. No.: US 2002/0049586 A1
(43) Pub. Date: Apr. 25, 2002

(54) Audio encoder, audio decoder, and broadcasting system

(76) Inventors: Kousuke Nishio, Moriguti City (JP); Takashi Katayama, Hirakata City (JP); Masaharu Matsumoto, Katano City (JP); Akihisa Kawamura, Hirakata City (JP); Takeshi Fujita, Takatsuki City (JP); Masahiro Sueyoshi, Hirakata City (JP); Kazutaka Abe, Toyonaka City (JP)

Correspondence Address: SMITH PATENT OFFICE, 1901 PENNSYLVANIA AVENUE N W, SUITE 200, WASHINGTON, DC, 20006

(21) Appl. No.: 09/949,025

(22) Filed: Sep. 11, 2001

(30) Foreign Application Priority Data
Sep. 11, 2000 (JP) 2000-274456

(51) Int. Cl. G10L 21/00; G10L 19/00

(52) U.S. Cl. 704/230

(57) ABSTRACT

In an audio encoder, a filter bank 3 converts sample data on a time domain divided in an audio signal input section 2 to spectral data on a frequency domain. A quantization section 4 quantizes and codes the spectral data on the frequency domain, and a bitstream multiplexer 6 outputs an audio codec stream. At this point, a quantization controller 5 compares quantization information to which an offset value has been added with the one to which an offset value has not been added, and the quantization section codes quantization information having a shorter code length. An audio decoder 7 decodes the audio codec stream generated in the audio encoder 1.

### BACKGROUND OF THE INVENTION

1. Field of the Invention

The present invention relates to an audio encoder for coding digital audio data, an audio decoder for decoding the audio codec stream outputted from the audio encoder, and broadcasting systems using these audio encoder and decoder.

2. Discussion of the Related Art

Currently, there have been developed various audio coding methods for compressing and encoding audio data. “MPEG-2 Advanced Audio Coding” is also one of such methods. The audio coding methods will be explained using an abbreviated designation of AAC hereinafter.

Details of AAC are found in a standard document called “IS 13818-7 (MPEG-2 Advanced Audio Coding, AAC).” In AAC, inputted digital audio signals are divided for each specified time, and sample data divided on a time domain are converted to spectrum data on a frequency domain. Then, the spectrum data are quantized, and the result of quantization is converted to a coded audio bitstream to output.

Hereinafter, there will be explained the formulas for the quantization and quantization algorithm used in AAC. In the practical AAC encoding processing, there have been provided such tools as Gain Control, TNS (Temporal Noise Shaping), Psychoacoustic Model, M/S Stereo, Intensity Stereo, and Prediction. There are cases where a block size switching and a bit reservoir are used. Here, there will be omitted the explanation on the use of these tools, the block size switching, and the use of the bit reservoir.

Quantization is performed using the following formula (1):

$$xQuant = ( int ) ( {( ( abs ) mdct \_line * {2}^{\frac{- ( sf \_decoder - SF \_OFFSET )}{4}} )}^{\frac{3}{4}} + MAGIC\_NUMBER ) \qquad ( 1 )$$

In formula (1), xQuant is a quantized value, mdct_line is spectral data on the frequency domain, that is, spectral data, and sf_decoder is a quantization coefficient defined for each scalefactor band. These quantized value and the quantization coefficient are called quantization information. Here, SF_OFFSET is defined as 100, and MAGIC_NUMBER is defined to 0.4054.

The spectral data on the frequency domain is classified into plural groups. Each of the groups includes one or more spectral data. Each group is often equivalent to simulate the critical band in human hearing area, and the data type in the group varies depending on an encoding method and on a data sampling frequency. For example, in AAC, when the sampling frequency handles data of 44.1 kHz, the number of spectral data on the frequency domain is 1024, and the number of groups is 49.

In the description of each embodiment, each of the groups is called “scalefactor band” or “subband.” Here, (sf_decoder-SF_OFFSET) is replaced with SCALEFACTOR. This causes the the formula for quantization to be expressed in formula (2):

$$xQuant = ( int ) ( {( ( abs ) mdct \_line * {2}^{\frac{- SCALEFACTOR}{4}} )}^{\frac{3}{4}} + MAGIC\_NUMBER ) \qquad ( 2 )$$

Quantized values in each group obtained by formula (1) or (2) are Huffman coded with 4-tuple or 2-tuple, and outputted as an audio codec stream. For formula (2), SCALEFACTOR is called the quantization coefficient. For AAC, a difference between adjacent quantization coefficients is calculated, and the resultant difference value is Huffman coded. Such Huffman coding is also used for layer-3 of MPEG-1 and the like, other than AAC.

However, in the abovementioned methods, there are several problems with respect to the improvement in sound quality. First object of the present invention is in what way a complex audio signal is to be coded. In Huffman coding, a codeword (coded value) with a short code length is set for tuples of quantized values with a high frequency in occurrence, while a codeword with a long code length is set for tuples of quantized values with a low frequency in occurrence. Mainly using of the codeword with a short code length allows a required amount of information to be reduced.

Speaking on the contrary, where as a result of quantization processing, many of tuples of quantized values with a low frequency are formed, the amount of required information may increase. In such a case, decoded and reproduced audio signals may not be obtained with high quality.

Second object of the present invention is an encoding method for a low transfer rate. When the maximum quantized value is large in a tuple of quantized values, the amount of information may increase. Although there is no problem for a high transfer rate, the maximum quantized value in a tuple of quantized values must be made small for a low transfer rate. However, when the maximum quantized value is small in a tuple of quantized values, the reproducibility of audio signals when decoded is lowered, causing a high sound quality not to be held.

As one of methods of solving the abovementioned problems, it is assumed to expand a Huffman codebook. For example, a new Huffman codebook is assigned to tuples of quantized values to which a long code length has been assigned, so that a short code length can be assigned to the tuples. The abovementioned problems may be solved by such method. However, expanding the Huffman codebook results in increase of causes a problem in that the amount of memory in an audio encoder and an audio decoder.

### SUMMARY OF THE INVENTION

The present invention is an audio encoder and an audio decoder to solve such problems. In an audio codec, a code with a short code length is adaptationally assigned to quantization information for reducing the amount of information. Thereby audio signal is reproduced with high sound quality even when the transfer rate is limited.

An audio encoder of the present invention includes an audio signal input section for slicing inputted audio signals for each specified time, a filter bank for converting sample data on a time domain thus divided by the audio signal input section to spectral data on a frequency domain, a quantization section for quantizing and coding the spectral data obtained in the filter bank to output an audio codec signal, a quantization controller for controlling a quantizing method and a coding method for the quantization section, and a bitstream multiplexer for converting the audio codec signal outputted from the quantization section to an audio codec stream to output. Then, the quantization section includes a quantizer, an offset value adder, an encoding unit, and a side information adder. The quantizer quantizes the spectral data according to a predetermined quantization format, and converts the data to first quantization information. The offset value adder, in setting n-kind offset values for the quantization information obtained by the quantizer, adds k-th (k=1, 2, . . . n) off set value to the first quantization information to be converted to second, third . . . (n+1)th quantization information, respectively. The encoding unit encodes the first quantization information to the (n+1)th quantization information according to a predetermined encoding format to generate first coded value to (n+1)th coded value, posts the code length of each coded value and the codebook name used for encoding to the quantization controller, and outputs one of the coded value having a shortest code length instructed from the quantization controller as an audio codec signal. The side information adder extracts an off set value used for a coded value selected by the quantization controller from respective offset values added by the offset adder, and adds the offset value and the codebook name used for encoding to the audio codec signal as side information. This allows the number of transmission bits of the audio codec signal to be reduced.

An audio decoder of the present invention includes a stream input section for converting an inputted audio codec audio stream to an audio codec signal and side information, an offset information output section for extracting offset information including both an offset value and a codebook name from the side information, an inverse quantization section for inputting an audio codec signal from the stream input section, executing decoding and inverse quantization by the use of the offset value and the codebook name obtained in the offset information output section, and converting the signal to spectral data on a frequency domain, an inverse filter bank for converting the spectral data on a frequency domain obtained in the inverse quantization section to sample data on a time domain, and an audio signal output section for sequentially combining the sample data on the time domain and outputting the combined data as an audio signal. The inverse quantization section includes a decoding unit, an offset value remover and an inverse quantizer. The decoding unit decodes an audio codec signal according to the quantization format obtained in the side information and outputs a first decoded quantization information. The offset value remover removes an offset value from the first decoded quantization information by the use of an offset value obtained from the offset information output section, and converts the first decoded quantization information to a second decoded quantization information. The inverse quantizer section converts the second decoded quantization information outputted from the offset value remover to a spectral data on the frequency domain. In this way, adding and outputting the offset value before coding the quantization information allows the data of audio stream to be made fewer.

The audio encoder and audio decoder of the present invention allow the data of audio stream to be made fewer by the addition of the offset value after coding quantization information.

Further, the audio encoder and audio decoder of the present invention allow the data of audio stream to be made fewer by the addition of the offset value to a table in which the quantization information is coded.

The broadcasting system of the present invention uses the audio encoder and audio decoder of the present invention, thereby transmitting an audio codec signal and allowing a high-sound-quality audio signal to be received even when the transfer rate is limited.

### BRIEF DESCRIPTION OF THE DRAWINGS

FIG. 1 is an illustrative chart showing part of Huffman tables 1 and 2 used f or each embodiment of the present invention;

FIG. 2 is an illustrative chart showing part of Huffman tables 7 and 8 used for each embodiment of the present invention;

FIG. 3 is an example of Huffman table used for an embodiment 1 of the present invention, showing the bit length for tuples of quantized values (1, 1, 1, 1);

FIG. 4 is an example of Huffman table used f or the embodiment 1 of the present invention, showing the bit length for tuples of quantized values (0, 0, 0, 0);

FIG. 5 is an example of Huffman table used for the embodiment 1 of the present invention, showing the bit length for tuples of quantized values (2, 1, 2, 1);

FIG. 6 is an example of Huffman table used for the embodiment 1 of the present invention, showing the bit length for tuples of quantized values (1, 0, 1, 0);

FIG. 7 is a block diagram showing a configuration of an audio encoder and an audio decoder in the embodiment 1 of the present invention;

FIG. 8 is a block diagram showing a relationship between a quantization section and a quantization controller in the audio encoder of the embodiment 1;

FIG. 9 is a block diagram showing a relationship between an inverse quantization section and an offset information output section in the audio decoder of the embodiment 1;

FIG. 10 is a data arranged chart (No. 1) of an audio codec stream formed in the audio encoder of the embodiment 1;

FIG. 11 shows a data arranged chart of an audio codec stream formed in the audio encoder of the embodiment 1, and is an example of a case where an offset value is set for each coded unit.

FIG. 12 shows a data arranged chart of an audio codec stream formed in the audio encoder of the embodiment 1, and is an example of a case where an offset value is set for a header;

FIG. 13 is an example of Huffman table used for an embodiment 2;

FIG. 14 is a block diagram showing a configuration of an audio encoder and an audio decoder in the embodiment 2 of the present invention;

FIG. 15 is a block diagram showing a relationship between a quantization section and a quantization controller in the audio encoder of the embodiment 2;

FIG. 16 is a block diagram showing a relationship between an inverse quantization section and an offset information output section in the audio decoder of the embodiment 2;

FIG. 17 is a block diagram showing a configuration of an audio encoder and an audio decoder in an embodiment 3 of the present invention;

FIG. 18 is a block diagram showing a relationship between a quantization section and a quantization controller in the audio encoder of the embodiment 3;

FIG. 19 is a block diagram showing a relationship between an inverse quantization section and an offset information output section in the audio decoder of the embodiment 3;

FIG. 20 shows a data arranged chart of an audio codec stream formed in the audio encoder of the embodiment 3, and is an example of a case where a pattern flag is set for each coding unit.

FIG. 21 shows a data arranged chart of an audio codec stream formed in the audio encoder of the embodiment 3, and is an example of a case where a reference pattern is set for each coding unit; and

FIG. 22 shows a data arranged chart of an audio codec stream formed in the audio encoder of the embodiment 3, and is an example of a case where a reference pattern is set for a header.

### DESCRIPTION OF THE PREFERRED EMBODIMENTS

With reference to drawings, an audio encoder and an audio decoder in embodiments of the present invention will be explained hereinafter.

### The Embodiment 1

An audio encoder and an audio decoder in an embodiment 1 of the present invention will be explained. The audio encoder in this embodiment converts digital audio data inputted on a time domain to that on a frequency domain, quantizes the data on the frequency domain, adds an offset value before Huffman coding, and outputs a bitstream which realizes a high sound quality even at a low bit rate.

The audio decoder in this embodiment inputs the bitstream outputted from the audio encoder, or regenerates a bitstream recorded on a recording media, and decodes the bitstream into digital audio data. Hence, the audio encoder includes a quantization section for executing quantization in a method different from prior art, and the audio decoder includes an inverse quantization section corresponding thereto.

First, a Huffman codebook used in AAC will be explained. When in a continuous frequency band, respective spectral data are converted to quantized values, and when what multiple quantized values are made one group is called tuples of quantized values, an index value is defined for each tuples of qauntized values. What is Huffman coding corresponding to each index value is called a Huffman codeword or a Huffman coded value. A table in which an index value corresponds to a Huffman codeword is called a Huffman code book. There are Huffman codebooks of number 0 to 11, and the smaller the number, the smaller the limited absolute quantized values is made.

The tuples of quantized values consists of four quantized values such as (a, b, c, d) or of two quantized values such as (e, f). In AAC, the range of values (absolute values) within quantized values a, b, c, d, e, f can be is 0 through 8191. For the Huffman codebook 1 or 2, quantized value a, b, c, or d has the maximum absolute value of 1, and has positive or negative sign. A relationship between the index value and the tuples of quantized values in this case will be explained. As shown in FIG. 1, the index value is expressed in four digits by the use of the ternary notation. What “1” is subtracted from each digit of values expressed in the ternary notation is defined as tuples of quantized values. Therefore, when four digits are established in values expressed in the ternary notation, there are present 81-kind indexes in total.

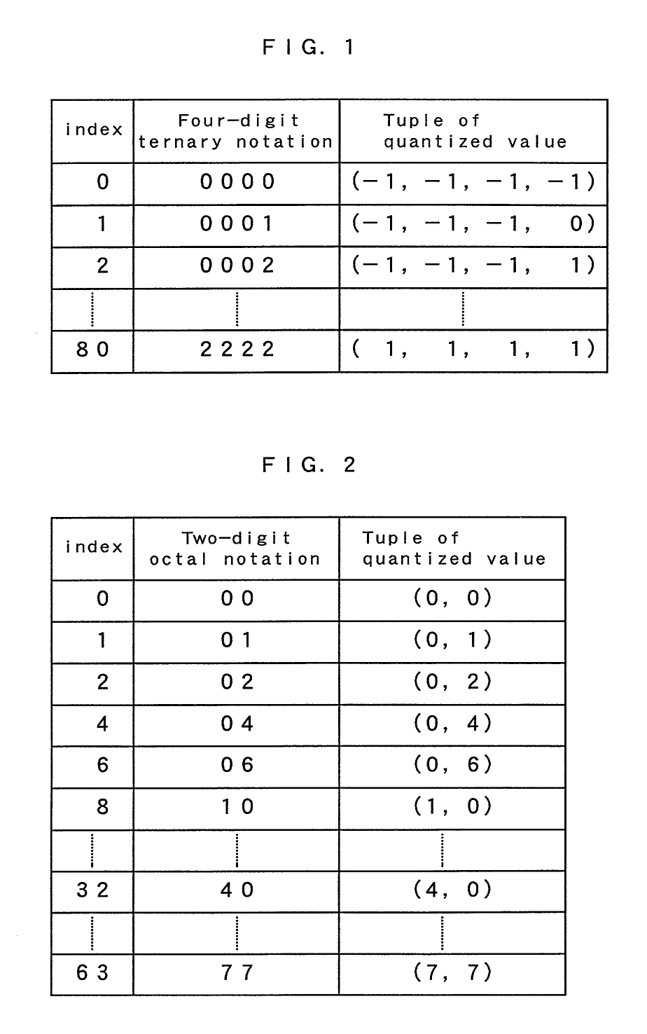

For the Huffman codebook 7 or 8, quantized value e or f has the maximum absolute value of 7, and has not positive or negative sign. As shown in FIG. 2, the index value is expressed in two digits by the use of octal notation, and what is expressed in two digits is defined as tuples of quantized values. Therefore, when two digits are established in values expressed in octal notation, there are present 64-kind indexes in total. In this case, the range of quantized values becomes larger than that of Huffman codebook 1 or 2.

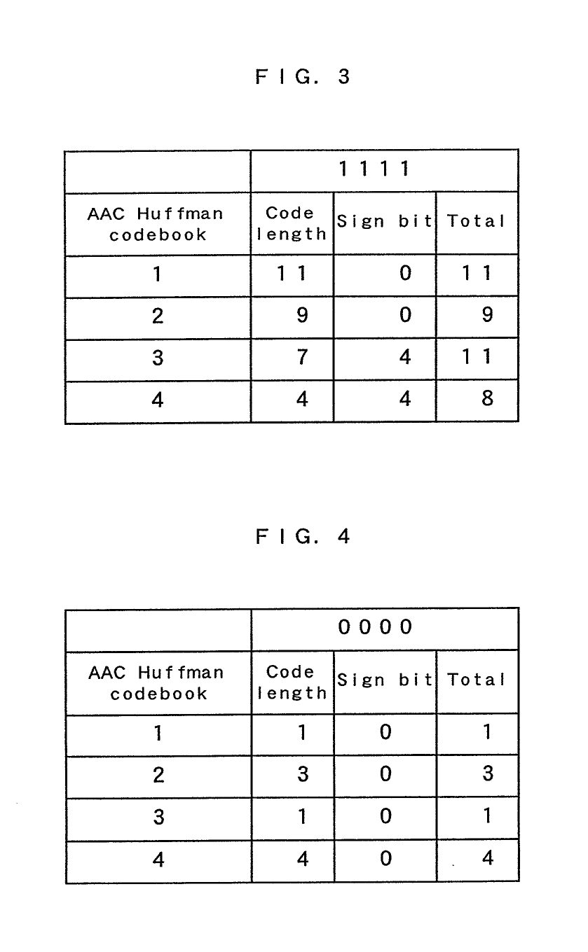

Here, the principle of encoding will be explained in the audio encoder of the present invention. FIG. 3 shows an example of a code length when tuples of quantized values (1, 1, 1, 1) is Huffman coded by the use of the Huffman codebooks 1 through 4 of AAC. However, in AAC, for the codebooks 1 and 2, quantized values with a positive or negative signs can be coded as they are, while for the codebooks 3 and 4, quantized values without such signs is coded. For the codebooks 1 and 2, the maximum value of quantized values capable of being coded is “1, ” while for the codebooks 3 and 4, the maximum value of quantized values capable of being coded is “2.”

FIG. 4 shows an example of a code length when tuples of quantized values (0, 0, 0, 0) is Huffman coded using the Huffman codebook of AAC. As shown in FIGS. 3 and 4, the code length when coding the tuples of quantized values (0, 0, 0, 0) becomes shorter than when coding the tuples of quantized values (1, 1, 1, 1). Hence, an offset value (−1) is added to each quantized value of the tuples of quantized values (1, 1, 1, 1) to be converted to the tuples of quantized values (0, 0, 0, 0), thereby allowing the amount of required information (Huffman code) to be made short.

The amount of information to which an offset value is added, if the offset value is assumed to be fixed value, exhibits (code length)+(flag indicating presence/absence of offset value)+(sign bit of original tuples of quantized values).

Where a Huffman codebook with a sign is used, the abovementioned (code length) is equal to the code length of the Huffman code.

Where a Huffman codebook without a sign is used, the abovementioned (code length) is equal to the code length of the Huffman code and the sign bit.

Therefore, the amount of information to which an offset value is added, if the codebook 1 is used, exhibits 1+1+4=6 as shown in FIG. 4. This means that the amount is fewer by five bits than a case where the same codebook 1 is used in the prior art.

For example, when an offset (−1) is added to tuples of quantized values (−2, 0,−1, 2), the tuples of quantized values exhibits (−3, −1, −2, 1), so that the maximum absolute value becomes larger from 2 to 3. However, in case an offset is added after removing the sign, the tuples of quantized values exhibits (1, −1, 0, 1), so that the maximum absolute value becomes smaller from 2 to 1. In this way, the maximum absolute value could be lowered by removing previously the sign bit. In this embodiment, the sign bit has been previously removed from the tuples of quantized values before Huffman coding. In this case, the sign bit is present in the tuples of quantized values before the offset value is added thereto, as well as in the tuples of quantized values after the offset value is added thereto. Here, the sign bit of the tuples of quantized values before the offset value is added thereto is called “sign bit of original tuples of quantized values” as described above.

As shown in FIG. 4, the amount of bits becomes smaller similarly in case of the Huffman codebook 3. When coded by the use of the codebook 3 after the offset value is added thereto, the amount of bits exhibits 1+1+4=6 bits. The amount becomes fewer by 5 bits than 11 bits at a time when coded by the use of the codebook 3 without addition of the offset value. The amount, when coded without addition of the offset value, becomes fewer by 2 bits than the codebook 4 in FIG. 3 in which the number of required bits becomes the minimum of 8.

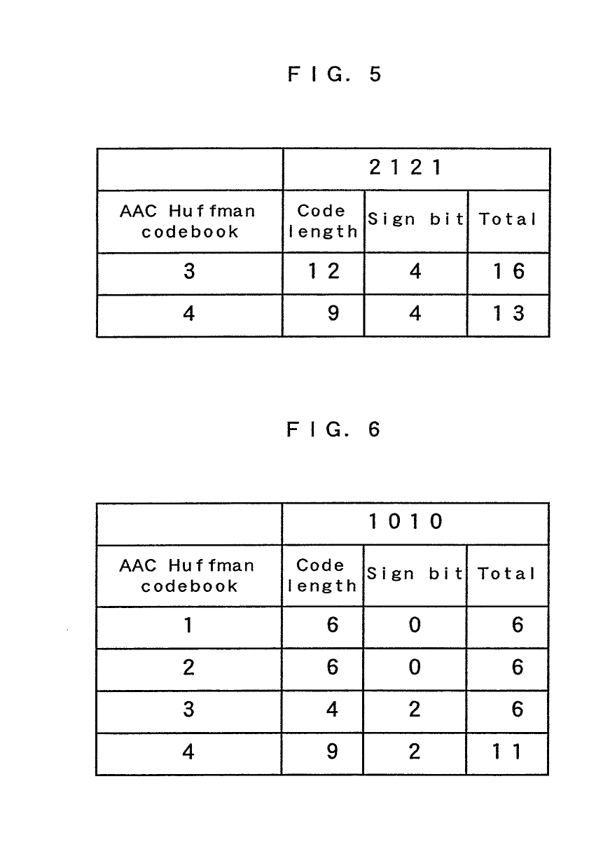

FIG. 5 shows an example of the code length when tuples of quantized values (2, 1, 2, 1) is Huffman coded in the Huffman codebook in AAC, as an example. Here, the absolute value of the quantized values has exceeded “1, ” so that Huffman codebooks 1 and 2 cannot be used. FIG. 6 shows an example of the code length when tuples of quantized values (1, 0, 1, 0) is Huffman coded in the Huffman codebook in AAC, as an example.

Similarly, the amount of information is calculated, when the offset value (−1) is added thereto. When Huffman codebook 1 is used, the amount exhibits 6+1+4=11 bits. When the codebook 2 and 3 are used, similar results are also obtained. When the codebook 4 is used in the prior art, the amount becomes 13 bits as shown in FIG. 5. When the codebook 2 and 3 are used for the quantized values (1, 0, 1, 0), the amount exhibits (6+1+4)=11 bits, as shown in FIG. 6. Thus, the amount becomes fewer by 2 bits. Further, even when the maximum absolute value of the quantized values is 2, the codebook 1 can be used, so that an increase in the amount of information due to codebook change can be prevented. The absolute value of the quantized values concentrates on 1 or 2 at a low transfer rate in particular, so that the abovementioned mechanism is effective.

In AAC, as described above, the quantized values are coded with 4-tuple or 2-tuple. In this embodiment, this is called coding unit. Though AAC has been used as an encoding method for description in this embodiment, the present invention is not limited thereto.

With respect to the abovementioned processing, whether the offset value is applied to each Huffman coding unit will be determined. Of course, where coding can be made with a smaller amount of information when the offset value is not used, the offset value will not be used. At that point, a flag indicating the use of the offset value becomes necessary for all coding units. Where a decrease in the amount of information due to the introduction of the offset value exceeds an increase in the amount of information due to the addition of the flag of the offset value, the present invention is very effective.

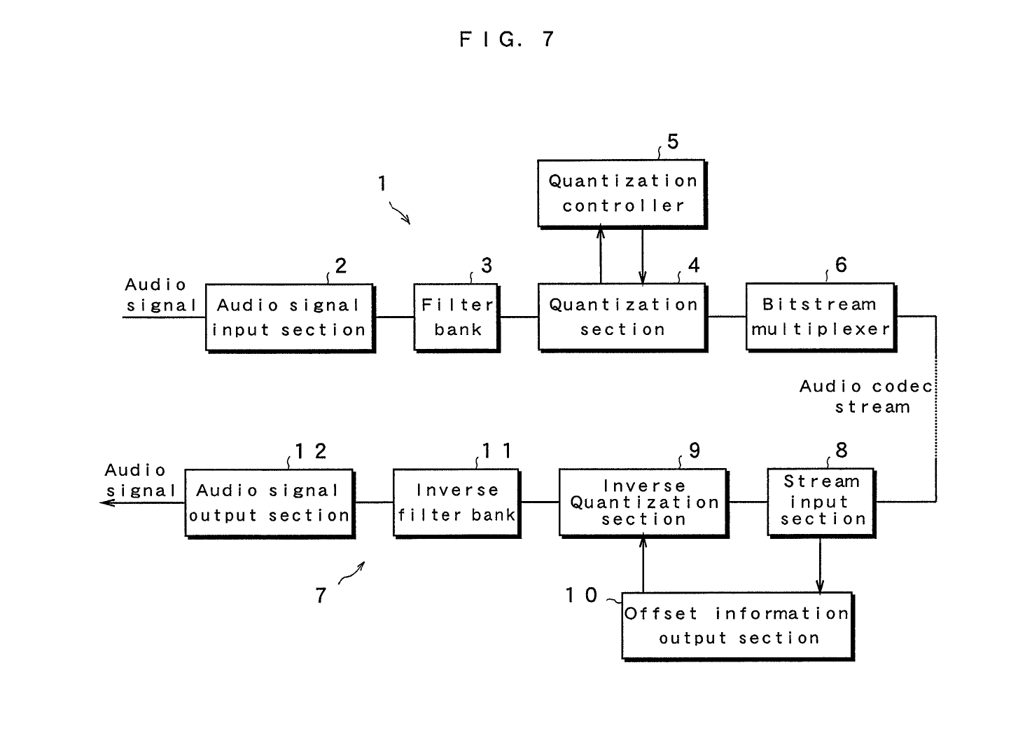

The configuration of an audio encoder and an audio decoder in the embodiment will be explained hereinafter with reference to FIGS. 7 to 9. FIG. 7 is a block diagram showing a general configuration of an audio encoder 1 and an audio decoder 7 of the embodiment 1. The audio encoder 1 includes an audio signal input section 2, a filter bank 3, a quantization section 4, a quantization controller 5, and a bitstream multiplexer 6. The audio signal input section 2 divides inputted digital audio data for each specified time. The filter bank 3 converts sample data on a time domain divided by the audio signal input section 2 to spectral data on a frequency domain. The quantization section 4 quantizes the spectral data on the frequency domain obtained from the filter bank 3, sets n-kind offset values for first quantization information thus obtained, converts the values to a first quantization information through an (n+1) th quantization information, and outputs information including both the offset values used for conversion and the codebook names to be referred to as side information.

The quantization controller 5 outputs a select control signal for controlling the quantization method and the encoding method to the quantization section 4. The bitstream multiplexer 6, when a Huffman code outputted from the quantization section 4 is assumed to be an audio codec signal, converts this audio codec signal and the side information to an audio codec stream to output.

The audio codec stream outputted from the audio encoder 1 is transmitted through a transmitting media to the audio decoder 7, or recorded on optical disks such as CD and DVD, and on recording media such as semiconductor memory.

The audio decoder 7 includes a stream input section 8, an inverse quantization section 9, an offset information output section 10, an inverse filter bank 11, and an audio signal output section 12. The stream input section 8 inputs an audio codec stream, which is inputted through a transmitting media or regenerated from a recording media, and converts the stream to an audio codec signal and side information. The offset information output section 10 extracts offset information including both offset values and codebook names from the side information, and outputs the information to the inverse quantization section 9.

The inverse quantization section 9 inputs the audio codec signal from the stream input section 8, uses the offset values and the codebook names obtained in the offset information output section 10 to execute decoding and inverse quantization, and converts it to spectral data on the frequency domain. The inverse filter bank 11 converts the spectral data on the frequency domain outputted from the inverse quantization section 9 to sample data on a time domain. The audio signal out put section 12 sequentially combines the sample data on the time domain obtained from the inverse filter bank 11 and outputs digital audio data.

In the practical audio decoder, for AAC, there are utilized tools such as Gain Control, TNS (Temporal Noise Shaping), Psychoacoustic Model, M/S Stereo, Intensity Stereo, and Prediction. There are cases where a block size switching and a bit reservoir are used. In this embodiment, the explanation on the use of these tools will be omitted.

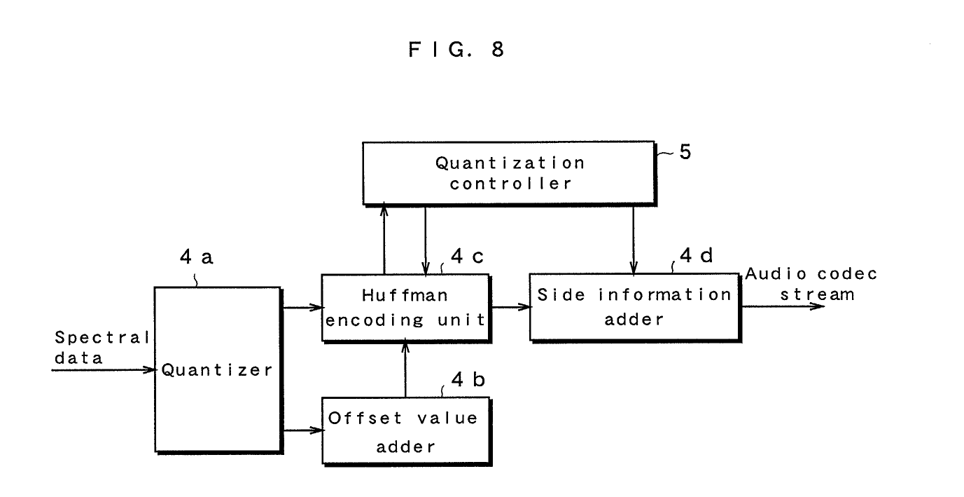

FIG. 8 is a block diagram showing more specifically a relationship between the quantization section 4 and the quantization controller 5 shown in FIG. 7. The quantization section 4 has a quantizer 4a, an offset value adder 4b, a Huffman encoding unit 4c, and a side information adder 4d.

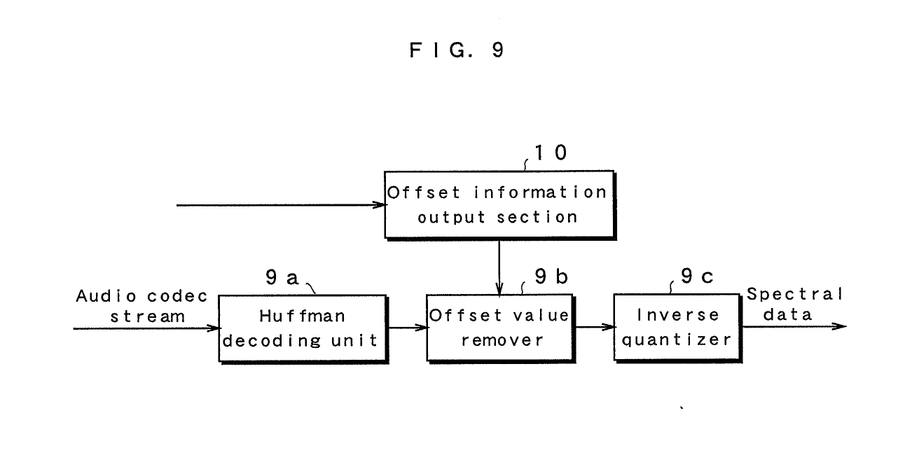

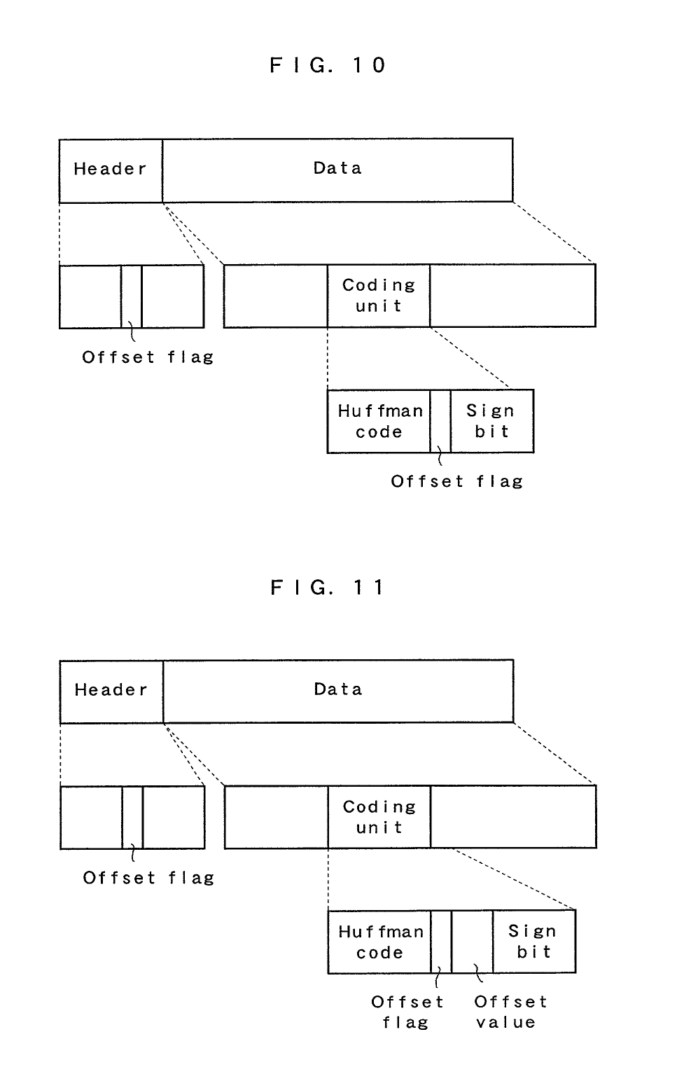

FIG. 9 is a block diagram showing a relationship between the inverse quantization section 9 and the offset information output section 10 shown in FIG. 7. The inverse quantization section 9 has a Huffman decoding unit 9a, an offset value remover 9b, and an inverse quantizer 9c.

The operation of this embodiment will be explained hereinafter. First, the audio signal input section 2 of FIG. 7 divides inputted digital audio data for each specified time. The filter bank 3 converts the sample data on the time domain divided in the audio signal input section 2 to the spectral data on the frequency domain, and outputs the data to the quantization section 4. The quantizer 4a of FIG. 8 quantizes the spectral data on the frequency domain outputted from the filter bank 3 according to a specified quantization format, and outputs first quantization information. The quantization information includes the abovementioned quantized values and quantization coefficient.

Then, the offset value adder 4b sets n-kind offset values for the quantization information obtained in the quantizer 4a. The offset value adder 4b adds k (k=1, 2, • • n)th offset value to the first quantization information, and coverts them to respective second, third • • (n+1)th quantization information. Here, the quantized values are discussed below. Assuming that the offset value of k=1 is (−1), the adder adds the offset value to the quantized value, and outputs a second quantized value. For example, if the first tuples of quantized value is (1, 1, 1, 1), then the second tuples of quantized value is (0, 0, 0, 0). At this point, tuples of quantized values is preferably separated into tuples of absolute values of quantized values and tuples of sign bits. For example, if tuples of quantized value is (1, −1, 1, −1), it is separated into (1, 1, 1, 1) and tuples of sign bits (0, 1, 0, 1). However, such method is not limited thereto.

Then, the Huffman encoding unit 4c codes first quantization information for to (n+1)th quantization information according to a specified quantization format. Then, the Huffman encoding unit 4c forms a first coded value to an (n+1)th coded value, and posts both the code length of respective coded values and codebook names used for coding to the quantization controller 5. Further, the Huffman encoding unit 4c outputs a coded value having a shortest code length instructed from the quantization controller 5 as an audio codec signal. In this way, the quantization controller 5 receives the coded results of the first quantization information to the (n+1)th quantization information outputted from the Huffman encoding unit 4c, selects one of the first to (n+1)th quantization information for each coding unit so as to make the amount of information smallest, and outputs the selected one.

The side information adder 4d extracts an offset value used for the coded value selected in the quantization controller 5 from respective offset values added by the offset value adder 4b. The adder 4d then adds both the offset value and the codebook name used for coding as side information to the audio codec signal. The adder 4d outputs an offset flag “1” when the offset value has been added, while the adder 4d outputs an offset flag 0 when the offset value has not been added.

The bitstream multiplexer 6 of FIG. 7 converts both the audio codec signal and the side information outputted from the quantization section 4 into an audio stream to output. The audio codec stream outputted from the bitstream multiplexer 6 is transmitted or stored on a recording media.

Either the audio stream transmitted or regenerated from the recording media is inputted into the audio decoder 7. The stream input section 8, when the audio codec stream is inputted, separates the stream into an audio codec signal and side information, and gives the audio codec signal to the inverse quantization section 9, and the side information to the offset information output section 10.

The Huffman decoding unit 9a of FIG. 9 conducts Huffman-decoding and changes the inputted audio codec stream according to the coding format obtained in the side information, and outputs first decoded quantization information. The offset information output section 10 extracts offset information including both the offset value and the codebook name from the inputted side information. The offset value remover 9b inputs the first decoded quantization information outputted from the Huffman decoding unit 9a, removes the offset value according to the offset value given by the offset information output section 10, and outputs the second decoded quantization information. As long as the decoding processing is properly executed, the decoded quantization information is the same as the quantization information in the audio encoder.

The inverse quantizer 9c inversely quantizes the second decoded quantization information outputted from the offset value remover 9b, and outputs spectral data on the frequency domain. The inverse filter bank 11 of FIG. 7 converts the spectral data on the frequency domain outputted from the inverse quantization section 9 to sample data on the time domain. The audio signal output section 12 combines the sample data outputted from the inverse filter bank 11, and outputs digital audio data.

The audio encoder and audio decoder of the embodiment are able to use the amount of information to be more effectively and to generate a higher sound quality audio codec stream compared with the prior art. In particular for the current AAC and the like, these can be embodied by only adding the offset value adder to the audio encoder and adding the offset value remover to the audio decoder without necessity of expanding of Huffman codebook. Of course, even when executing the expanding Huffman codebook, this method becomes effective.

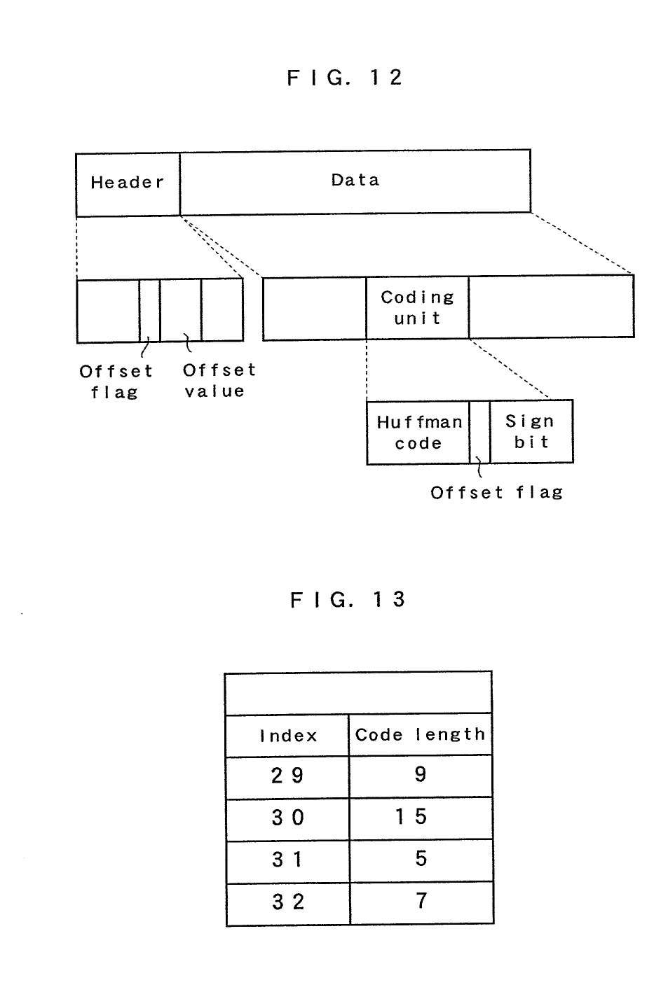

FIG. 10 shows an example of a stream formed in this embodiment. A recording region of an offset flag is provided in the header portion within the stream. Then, recording regions for Huffman code, offset flag and sign bit are provided in regions of coding units of the data portion. Where the offset value is not used in all coding units to execute an efficient coding, the offset flag of the header is made off. This allows an offset information field in the data portion to be reduced. The position of the offset information field is not limited one shown in FIG. 10.

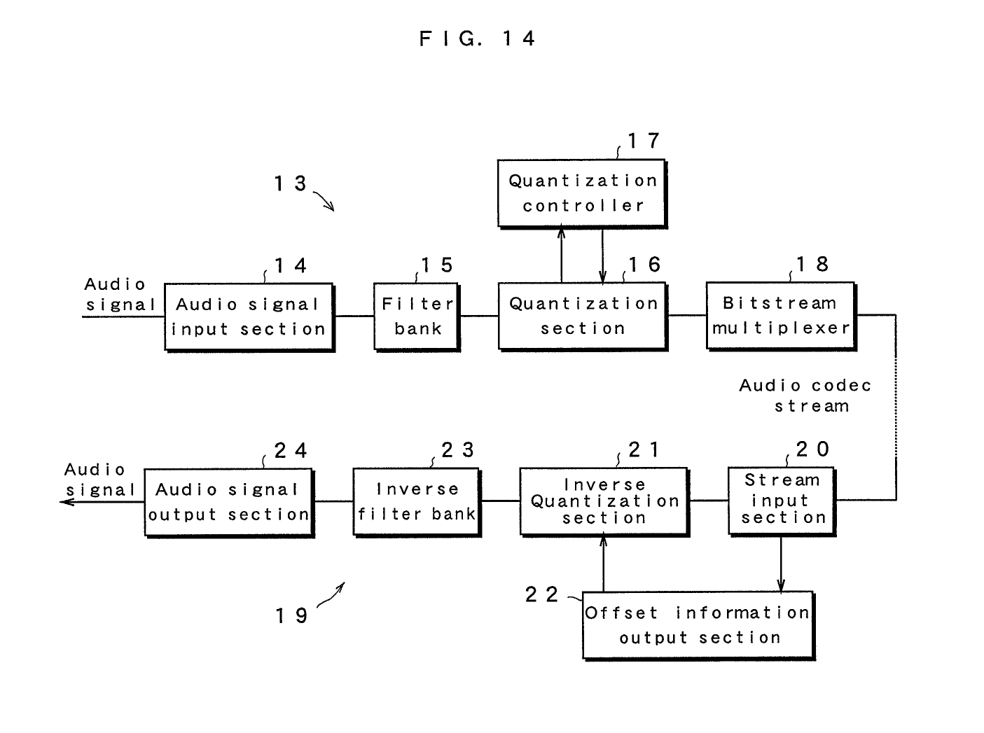

While in this embodiment, the offset value has been fixed, the offset value may be variable. FIG. 11 shows an example of a stream in which the offset value is variable for each coding unit. FIG. 12 shows an example of a stream in which the offset value is variable for each frame unit. The position of the offset information field is not limited those shown in FIGS. 11 and 12. While the offset value, as it is, may be used in the information field of offset values, the index of a predetermined offset value table may be used to execute effective coding.

By expanding the index of Huffman table, the offset value may be expressed. Where the offset value is variable for each continuing unit, and the offset values in the continuous coding unit are the same, the offset of the continuous following coding unit may not be transmitted in order to encode more effectively. Furthermore, offset information may be grouped and Huffman-coded to encode effectively.

In the abovementioned description, the quantization section 4 is designed to add the offset value to the quantized value obtained in the quantizer, that is, to xQuant of formula (1) or (2), and at the same time, to add the offset value also to sf_decoder in formula (1) or SCALEFACTOR in formula (2), that is, to quantization coefficient. Here, the offset value for quantization coefficient may be added to the quantization coefficient itself, and where a difference between adjacent quantization coefficients is coded to transmit, the offset value may be added to the difference. However, adding the offset value to only the quantized value xQuant, or adding the offset value to only the quantization coefficient allows the amount of codes to be significantly reduced. In this way, adding the offset value to at least the quantized value or the quantization coefficient allows the amount of bits of audio streams of the audio encoder to be reduced.

The abovementioned processing can be embodied in software as well as in hardware, and part thereof can be embodied in hardware and the rest in software. The function of the abovementioned audio encoder and audio decoder can be provided as a program executable by a computer. Such coding processing program or decoding processing program can be down loaded into a server for executing music delivery through network, or a personal computer for receiving the delivered music data. Such programs can be recorded on a recording media as application programs for music delivery to provide to users.

### The Embodiment 2

An audio encoder and an audio decoder according to an embodiment 2 of the present invention will be explained hereinafter. The audio encoder in this embodiment converts digital audio data inputted on a time domain to that on a frequency domain, quantizes the data on the frequency domain, and adds an offset value to an index to which is referred in executing Huffman coding. This allows the audio encoder to output a bitstream which realizes a high sound quality even at a low bit rate. The audio decoder in this embodiment decodes the bitstream generated in the abovementioned audio encoder, and outputs digital audio data.

Before describing the configuration of the audio encoder and the audio decoder, the principle of the encoding of the present embodiment will be explained. The Huffman codebook in AAC is designed to determine an index by tuples of quantized values and the quantization coefficient, and transmit a codeword corresponding to the index. The correspondence between the index and the codeword has been previously determined. Hence, when coding tuples of quantized values and the quantization coefficient corresponding to the index indicating a codeword having a long code length, the amount of required information has been increased.

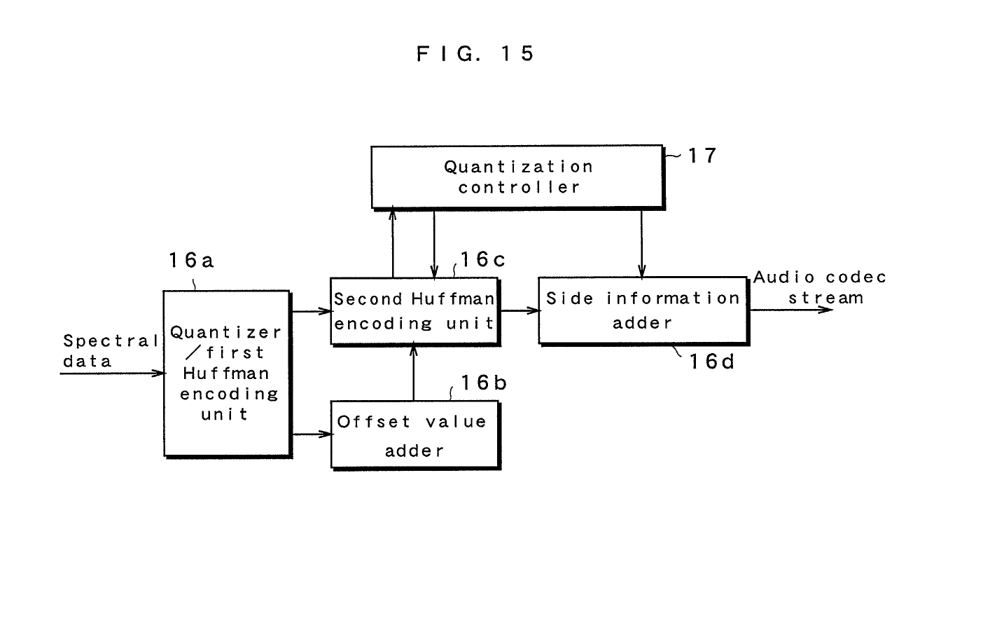

In this embodiment, the offset value is added to the index calculated from tuples of quantized values and the quantization coefficient to change the index, so that the index can be transmitted with a shorter coded value (codeword). FIG. 13 shows apart of Huffman codeword. According to this figure, for example, the code length is 15 when the index is 30, while the code length is 5 when the index is 31. Thus, when the index is 30, the offset value 1 is added to render the second index 31, whereby the amount of required information can be reduced.

In the abovementioned processing, whether the offset value is set for each Huffman coding unit will be determined. Where coding can be made with a smaller amount of information when the offset value is not used, the offset value will not be used. In this case, a flag indicating the use of the offset value becomes necessary for all coding units.

The present embodiment very effective where a decrease in the amount of information due to the introduction of the offset value exceeds an increase in the amount of information due to the addition of the flag of the offset value. In AAC, with two or four quantized values being made a tuple, Huffman coding is made in tuple units. In this embodiment, this is called coding unit.

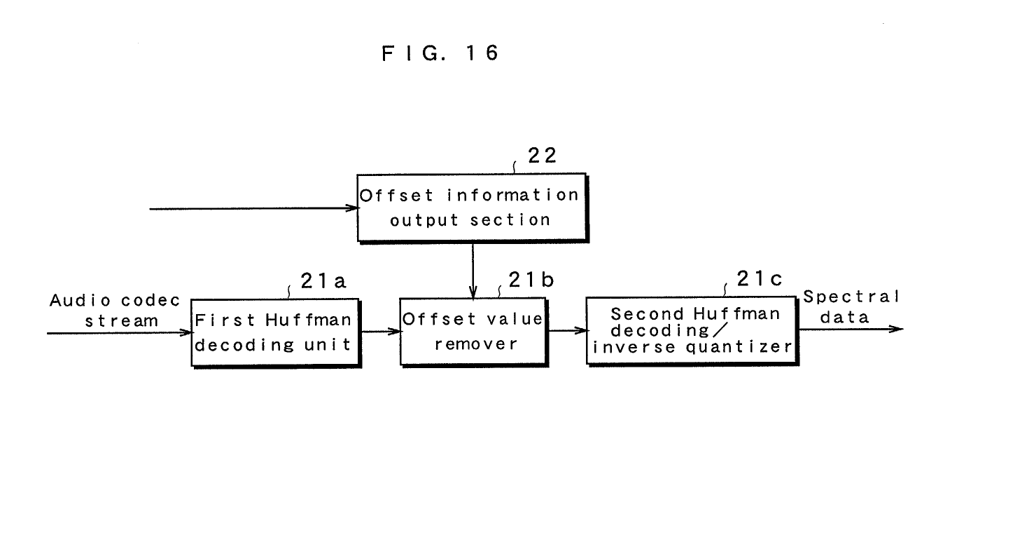

The configuration of the audio encoder and audio decoder in this embodiment will be explained hereinafter with reference to FIGS. 14 to 16. FIG. 14 is a block diagram showing a general configuration of an audio encoder 13 and an audio decoder 19 of this embodiment. The audio encoder 13 includes an audio signal input section 14, a filter bank 15, a quantization section 16, a quantization controller 17, and a bitstream multiplexer 18.

The audio signal input section 14 divides inputted digital audio data for each specified time. The filter bank 15 converts sample data on a time domain divided by the audio signal input section 14 to spectral data on a frequency domain. The quantization section 16 quantizes and executes Huffman coding for the spectral data on the frequency domain obtained by the filter bank 15, thereby converting the data to audio codec signal. The quantization controller 17 controls the quantization method and the Huffman coding method of the quantization section 16. The bitstream multiplexer 18 converts the audio codec signal and the side information outputted from the quantization section 16 to an audio codec stream. This audio codec stream is outputted to a transmitting media, or stored on a recording media.

The audio decoder 19 includes a stream input section 20, an inverse quantization section 21, an offset information output section 22, an inverse filter bank 23, and an audio signal output section 24. The stream input section 20 inputs an audio codec stream, which is inputted through a transmitting media or regenerated from a recording media, and separates the stream into audio codec signal and side information. The offset information output section 22 extracts offset information including both offset values and codebook names from the side information. The inverse quantization section 21 inputs the audio codec signal from the stream input section 20, uses the offset values and the codebook names obtained in the offset information output section 22 to execute Huffman decoding and inverse quantization, and converts it to spectral data on the frequency domain.

The inverse filter bank 23 converts the spectral data on the frequency domain outputted from the inverse quantization section 21 to sample data on the time domain. The audio signal output section 24 sequentially combines the sample data on the time domain obtained from the inverse filter bank 23 and outputs digital audio data.

Although in the practical audio decoder using AAC, there are utilized tools such as Gain Control, TNS (Temporal Noise Shaping), Psychoacoustic Model, M/S Stereo, Intensity Stereo, and Prediction, the explanation on the use of these tools will be omitted in this embodiment. Although there are cases where a block size switching and a bit reservoir are used, the explanation on the use of these tools will be also omitted.

FIG. 15 is a block diagram showing a relationship between the quantization section 16 and the quantization controller 17 shown in FIG. 14. The quantization section 16, as shown in this figure, has a quantization/first Huffman encoding unit 16a, an offset value adder 16b, a second Huffman encoding unit 16c, and a side information adder 16d.

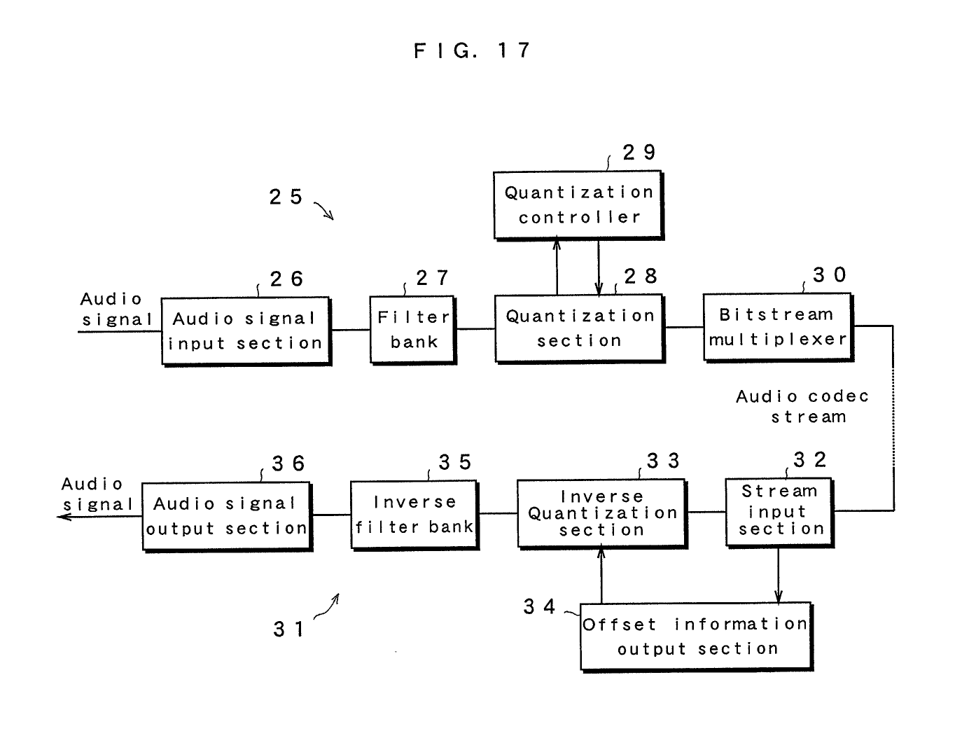

FIG. 16 is a block diagram showing a relationship between the inverse quantization section 21 and the offset information output section 22 shown in FIG. 14. As shown in this figure, the inverse quantization section 21 has a first Huffman decoding unit 21a, an offset value remover 21b, and a second Huffman decoding/inverse quantizer 21c.

The operation of the audio encoder 13 and the audio decoder 19 will be explained herein after. The audio signal input section 14 of FIG. 14 divides inputted digital audio data for each specified time. The filter bank 15 converts the sample data on the time domain divided in the audio signal input section 14 to the spectral data on the frequency domain, and outputs the data to the quantization section 16.

The quantization/first Huffman encoding unit 16a of FIG. 15 quantizes the spectral data according to a specified quantization format to convert the data to quantized values and quantization coefficients, and the quantization/first Huffman encoding unit 16a calculates a first Huffman code index on the basis of the quantized values and the quantization coefficient. Similar to the embodiment 1, the quantized values (xQuant) and the quantization coefficient (sf_decoder or SCALEFACTOR) in formula (1) or (2) are called quantization information.

The offset value adder 16b sets n-kind offset values for the first Huffman code index obtained in the quantization/first Huffman encoding unit 16a. The offset value adder 16b adds k (k=1, 2, • • n)th offset value to the first Huffman code index, and coverts them to respective second, third to (n+1)th Huffman code index.

The second Huffman encoding unit 16c codes the Huffman code indexes of the first Huffman code index to the (n+1) th Huffman code index according to a specified Huffman coding format to form coded values of a first coded value to an (n+1)th coded value. Then, the second Huffman encoding unit 16c posts both the code length of respective coded values and codebook names used for coding to the quantization controller 17, and outputs a coded value having a shortest code length instructed from the quantization controller 17 as audio codec signal.

The side information adder 16d extracts an offset value used for the coded value selected in the quantization controller 17 from respective offset values added by the offset value adder 16b, and adds both the offset value and the codebook name used for coding as side information to the audio codec signal. The side information adder 16d outputs an offset flag “1” when the offset value has been added, while the adder outputs an offset flag 0 when the offset value has not been added. The bitstream multiplexer 18 of FIG. 14 converts both the audio codec signal and the side information outputted from the quantization section 16 into an audio stream.

The audio codec stream outputted from the bitstream multiplexer 18 is transmitted to a transmitting media or stored on a recording media. The audio codec stream is inputted into the audio decoder 19. The stream input section 20, when the audio codec stream is inputted, gives an audio codec signal to the inverse quantization section 21, and the side information to the offset information output section 22.

The first Huffman decoding unit 21a of FIG. 16 executes Huffman decoding for the inputted audio codec stream, and outputs the first Huffman code index. The offset information output section 22 extracts offset information from the inputted side information. The offset value remover 21b removes the offset value from the first Huffman code index by the use of the offset value obtained from the offset information output section 22, and converts the index to a second Huffman code index. The second Huffman decoding/inverse quantizer 21c executes a second Huffman decoding by the use of the second Huffman code index outputted from the offset value remover 21b to convert into decoded quantization information, and at the same time, converts the decoded quantization information to spectral data on the frequency domain.

The inverse filter bank 23 of FIG. 14 converts the spectral data on the frequency domain outputted from the inverse quantization section 21 to sample data on the time domain. The audio signal output section 24 combines the sample data out putted from the inverse filter bank 23, and outputs the data as digital audio data.

The audio encoder and audio decoder of the embodiment are able to use the amount of information more effective than the prior art. Thus, an audio codec stream of high sound quality can be generated. In particular for the current AAC and the like, these can be embodied by only adding the offset value adder to the audio encoder and adding the offset value remover to the audio decoder without necessity of expanding of Huffman codebook. Of course, even when executing the expanding Huffman codebook, this method becomes effective.

FIG. 10 shows an example of a stream formed in this embodiment similarly to the embodiment 1. Where the offset value is not used in all coding units to execute an efficient coding, the offset flag of the header is made off. This allows an offset information field in the data portion to be reduced. The position of the offset information field is not limited one shown in FIG. 10. While in this embodiment, the offset value has been fixed, the offset value may be variable.

FIG. 11 shows an example of a stream in which the offset value is variable for each coding unit similarly to the embodiment 1. FIG. 12 shows an example of a stream in which the offset value is variable for each frame unit. The position of the offset information field is not limited thereto shown. While the offset value, as it is, may be used in the information field of offset values, the index of a predetermined offset value table may be used to execute more-effective coding.

The offset value may be expressed by expanding the index of Huffman table. When the offset value is made variable for each coding unit, and when the offset values in the continuous coding unit are the same, the offset of the continuous following coding unit may not be transmitted. In this case more effective coding is performed. To execute more-effective coding, offset information may be grouped together to provide Huffman coding.

In the abovementioned description, it is designed to add the offset value to the information in which respective quantized value and quantization coefficient have been Huffman coded. However, adding the offset value to only the Huffman coded information, or adding the offset value to only the quantization coefficient allows significant effect to be obtained.

The abovementioned processing can be embodied in software as well as in hardware, and part thereof can be embodied in hardware and the rest in software. The function of the abovementioned audio encoder and audio decoder can be provided as a program executable by a computer. Such coding processing program or decoding processing program can be down loaded into a server for executing music delivery through network, or a personal computer for receiving the delivered music data. Such programs can be recorded on a recording media as application programs for music delivery to provide to users.

### The Embodiment 3

An audio encoder and an audio decoder according to an embodiment 3 of the present invention will be explained hereinafter. The audio encoder in this embodiment converts digital audio data inputted on a time domain to that on a frequency domain, and quantizes the data on the frequency domain execute to Huffman coding for the data. At this point, the audio encoder executes a recombination of the index of Huffman codebook and the Huffman codeword to generate first reference pattern to n-th reference pattern. Then, in coding tuples of quantized values and quantization coefficients, a reference pattern is selected to provide a shortest bit length. In this way, a bitstream having a high sound quality is outputted even at a low bit rate. The audio decoder in this embodiment decodes the bitstream generated by the abovementioned audio encoder, and outputs digital audio data.

The principle of the encoding used in this embodiment will be explained. The Huffman codebook is used to determine an index by tuples of quantized values and the quantization coefficient, and transmit a coded value (codeword) corresponding to the index. The correspondence between the index and the coded value has been previously determined. Hence, when coding tuples of quantized values having a long code length, the amount of required information has been increased.

In this embodiment, by changing of a reference pattern of an index calculated from tuples of quantized values and of a coded value, a shorter codeword can be transmitted. In the Huffman codebook shown in FIG. 13, the code length is 15 when the index is 30, while the code length is 5 when the index is 31. Thus, a codeword for the index 31 is transmitted when the index is 30. A codeword for another index is transmitted when the index is 31. In this way, by modifying of existing Huffman codebooks, the second reference pattern to n-th reference pattern are generated, thereby reducing the amount of required information.

In the abovementioned processing, among the first, second, third to n-th reference patterns, which reference pattern is to be applied will be determined for each Huffman coding unit. Where coding can be made with a smaller amount of information when the second or later reference pattern is not used, the basic reference pattern which is the first reference pattern will be used. When using the second or later reference pattern, the reference pattern number becomes necessary for all coding units. The present embodiment is very effective where a decrease in the amount of information due to the introduction of reference patterns different from each other exceeds an increase in the amount of information due to the addition of the reference pattern number. In AAC, with the two or four quantized values being a tuple, Huffman coding is made in tuple units. In this embodiment, this is called coding unit.

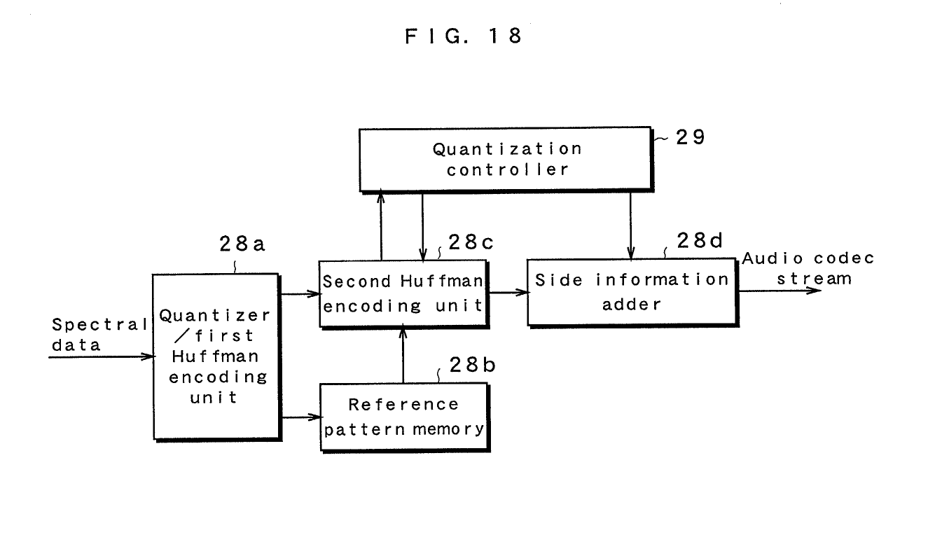

The configuration of an audio encoder and an audio decoder in this embodiment will be explained hereinafter with reference to FIGS. 17 to 19. FIG. 17 is a block diagram showing a general configuration of an audio encoder 25 and an audio decoder 31 of this embodiment. The audio encoder 25 includes an audio signal input section 26, a filter bank 27, a quantization section 28, a quantization controller 29, and a bitstream multiplexer 30.

The audio signal input section 26 divides inputted digital audio data for each specified time. The filter bank 27 converts sample data on a time domain divided by the audio signal input section 26 to spectrum data on a frequency domain. The quantization section 28 quantizes and execute Huffman coding for the spectral data on the frequency domain, thereby converting the data to an audio codec signal.

The quantization controller 29 controls the quantization method and the Huffman coding method to the quantization section 28. The bitstream multiplexer 30 converts both the audio codec signal outputted from the quantization section 28 and the side information including reference pattern numbers to an audio codec stream to output. This audio codec stream outputted from the audio encoder 25 is transmitted through a transmitting media to the audio decoder 31, or stored on a recording media.

The audio decoder 31 includes a stream input section 32, an inverse quantization section 33, a reference pattern information output section 34, an inverse filter bank 35, and an audio signal output section 36. The stream input section 32 inputs an audio codec stream, which is inputted through a transmitting media or regenerated from a recording media, and separates the stream into audio codec signal and side information. The reference pattern information output section 34 extracts reference pattern information including reference pattern numbers from the side information.

The inverse quantization section 33 inputs the audio codec signal from the stream input section 32, uses the reference pattern number obtained in the reference pattern information output section 34 to execute Huffman decoding and inverse quantization, and converts it to spectral data on the frequency domain. The inverse filter bank 35 converts the spectral data on the frequency domain obtained from the inverse quantization section 33 to sample data on the time domain. The audio signal output section 36 sequentially combines the sample data on the time domain obtained from the inverse filter bank 35 and outputs digital audio data.

Although in the practical audio decoder using AAC, there are utilized tools such as Gain Control, TNS (Temporal Noise Shaping), Psychoacoustic Model, M/S Stereo, Intensity Stereo, and Prediction, the explanation on the use of these tools will be omitted in this embodiment.

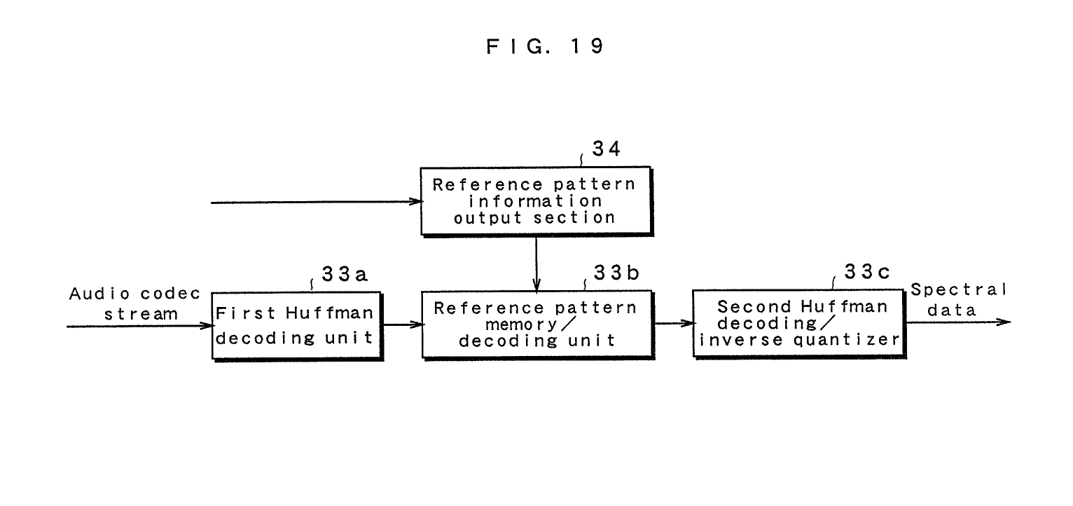

FIG. 18 is a block diagram showing a relationship between the quantization section 28 and the quantization controller 29 shown in FIG. 17. The quantization section 28, as shown in this figure, has a quantization/first Huffman encoding unit 28a, a reference pattern memory 28b, a second Huffman encoding unit 28c, and a side information adder 28d.

FIG. 19 is a block diagram showing a relationship between the inverse quantization section 33 and the reference pattern information output section 34 shown in FIG. 17. As shown in this figure, the inverse quantization section 33 has a first Huffman decoding unit 33a, a reference pattern memory/decoding unit 33b, and a second Huffman decoding unit/inverse quantizer 33c.

The operation of the audio encoder 25 and the audio decoder 31 will be explained herein after. The audio signal input section 26 divides inputted digital audio signal for each specified time. The filter bank 27 converts the sample data on the time domain divided in the audio signal input section 26 to the spectral data on the frequency domain, and outputs the data to the quantization section 28.

The quantization/first Huffman encoding unit 28a of FIG. 18 quantizes the spectral data according to a specified quantization format to convert the data to the quantization information including quantized values and quantization coefficients, and the quantization/first Huffman encoding unit 28a calculates a first Huffman code index on the basis of the quantization information. The reference pattern memory 28b stores the reference pattern for respective Huffman code index and for the Huffman coded values corresponding to the index. The second Huffman encoding unit 28c execute Huffman coding to the quantization information by the use of the first Huffman code index to the n-th Huffman code index to form Huffman coded values of a first Huffman coded value to an n-th Huffman coded value. Then, the second Huffman encoding unit 28c posts both the code length of respective coded values and the reference pattern numbers used for coding to the quantization controller 29. The second Huffman encoding unit 28c outputs a Huffman coded value having a shortest code length instructed from the quantization controller 29 as audio codec signal.

The quantization controller 29 controls the quantization method and the Huffman coding method for the quantization section 28. The side information adder 28d adds a reference pattern number used for the coded value selected in the quantization controller 29 among respective reference patterns stored on the reference pattern memory 28b to an audio codec signal as side information. The bitstream multiplexer 30 of FIG. 17 converts both the audio codec signal and the side information including reference pattern numbers outputted from the quantization section 28 into an audio codec stream to output.

The audio codec stream outputted from the bitstream multiplexer 30 is transmitted to a transmitting media or stored on a recording media. The stream input section 32 inputs the audio codec stream, separates the stream into audio codec signal and side information, and gives the audio codec signal to the inverse quantization section 33, and the side information to the reference pattern information output section 34.

The first Huffman decoding unit 33a of FIG. 19 inputs an audio codec signal and executes Huffman decoding for the signal. The reference pattern information output section 34 extracts reference pattern information including reference pattern numbers from the side information. The reference pattern memory/decoding unit 33b stores n-tuple assignment tables for the Huffman decoded value and the index corresponding to respective reference pattern numbers, and the reference pattern memory/decoding unit 33b outputs a reference pattern used for the current decoding.

The second Huffman decoding unit/inverse quantizer 33c determines an index corresponding to the decoded quantization information obtained in the first Huffman decoding unit 33a by the use of both the reference pattern number and a specified reference pattern, and acquires the decoded quantization information from the index value thus obtained.

The inverse filter bank 35 of FIG. 17 converts the spectral data on the frequency domain outputted from the inverse quantization section 33 to sample data on the time domain. The audio signal output section 36 combines the sample data outputted from the inverse filter bank 35, and outputs the data as digital audio data.

The audio encoder and audio decoder of the embodiment are able to use the amount of information more effectively as compared with the prior art. Thus, an audio codec stream of high sound quality is generated. In particular for the current AAC and the like, the audio stream can be processed by adding the reference pattern memory to the audio encoder and adding the reference pattern memory/decoding unit to the audio decoder without necessity of expanding of Huffman codebook. Of course, even when executing the expanding Huffman codebook, this method becomes effective.

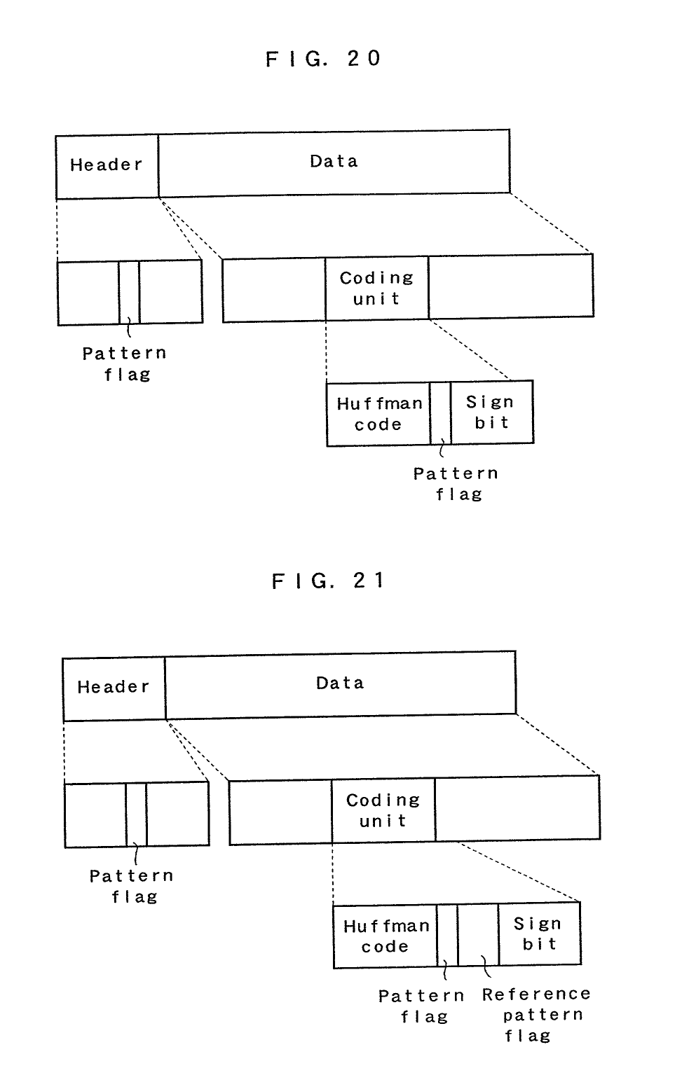

FIG. 20 shows an example of a stream formed in this embodiment. Where the reference patterns other than the first one is not used in all coding units to execute efficient coding, the reference pattern flag of the header is made off. This allows a reference pattern information field in the data portion to be reduced. The position of the reference pattern information field is not limited to the one shown in FIG. 20.

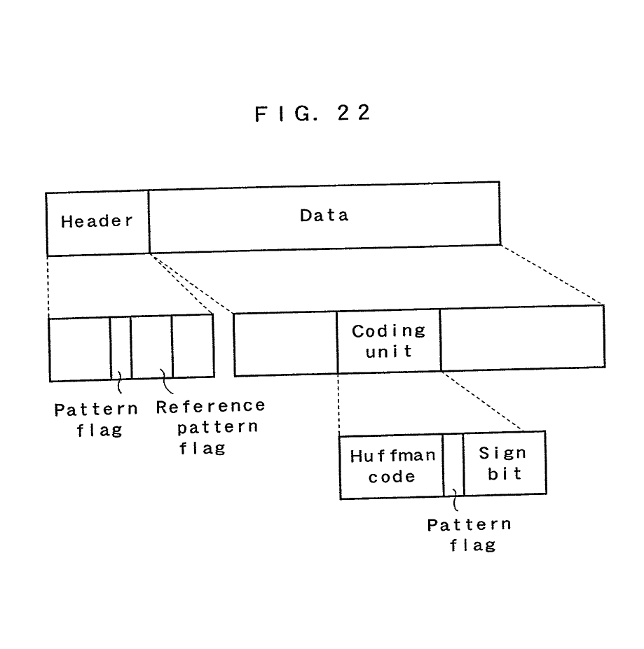

FIG. 21 shows an example of a stream in which the reference pattern is made variable for each coding unit. FIG. 22 shows an example of a stream in which the reference pattern is made variable for each frame unit. The position of the reference pattern information field is not limited thereto shown. By expanding the index indicating of Huffman table number, the reference pattern may be expressed.

When the reference pattern is made variable for each coding unit, and the reference patterns in the continuous coding unit are the same, the reference pattern of the continuous following coding unit may not be transmitted in order to encode more effectively. Furtheremore, reference pattern information may be grouped and Huffman-coded to encode effectively.

In the abovementioned description, it is designed to add the offset value to the information in which respective quantized value and quantization coefficient have been Huffman coded. However, adding the offset value only to the information in which quantized value has been Huffman-coded allows a significant effect to be obtained. Or adding the offset value to only the information in which the quantization coefficient has been Huffman coded allows also a significant effect to be obtained.

The abovementioned processing can be embodied in software as well as in hardware. A part there of can be embodied in hardware and the rest in software. The function of the abovementioned audio encoder and audio decoder can be provided as a program executable by a computer. Such coding processing program or decoding processing program can be down loaded into a server for executing music delivery through network, or a personal computer for receiving the delivered music data. Such programs can be recorded on a recording media as application programs for music delivery to provide to users.

When the audio codec stream generated in the audio encoder of embodiments is recorded on optical disks including CD and DVD, or on the semiconductor memory including EEPROM, the transfer rate assigned to audio signals have been limited occasionally. For example, when an audio signal of multi-channel is recorded on a recording media by the use of AAC, the transfer rate to each channel depends on a sampling rate, the number of channels, access rate of recording media itself and the like. When music delivery is preformed by the utilization of the Internet, the bit rate varies depending on connecting channel. There are many cases where the transfer rate is lower than the bit rate at the play back of a recording media. When a larger amount of quantized data are transmitted at a such limited transfer rate, it is desirable to reduce the amount of codes without deteriorating sound quality. The encoding method of the present invention allows the audio signals to be recorded and reproduced with a smaller amount of codes while succeeding to the property of AAC.

The limit of the transfer rate exists also in digital broadcasting. The transmitter is provided with the abovementioned audio encoder, while the receiver is provided with the abovementioned audio decoder. For the receiver as home appliances, it is desirable that the audio decoder is integrated into one chip to reduce the cost. In this case, a fewer kinds of AAC Huffman codebooks to which is to be referred provides an advantage to the achieving of IC. In the embodiments of the present invention, the Huffman codebooks having a long code length are substantially not used, so that the registration or storage of these Huffman codebooks can be omitted.

While in the abovementioned embodiments, the Huffman coding has been used as an audio codec, another mechanism, if it is entropy coding, may be sufficient.

As described above, according to the audio encoder and the audio decoder of the embodiment 1, an offset value is added to a quantized value when executing coding, and the offset value is removed when executing decoding, whereby a coded stream can be more efficiently transmitted or stored. Thus, even when the transfer rate is limited, the sound quality of an audio signal can be assured when executing quantizing.

According to the audio encoder and the audio decoder of the embodiment 2, an offset value is added to a Huffman index when executing coding, and the offset value is removed when executing decoding, whereby a coded stream can be more efficiently transmitted or stored. Thus, even when the transfer rate is limited, the sound quality of an audio signal can be assured when executing quantizing.

According to the audio encoder and the audio decoder of the embodiment 3, a reference pattern of conventional Huffman table is changed when executing coding, and the reference pattern is used for decoding when executing decoding, whereby a coded stream can be more efficiently transmitted or stored. Thus, even when the transfer rate is limited, the sound quality of audio signal can be assured when executing quantizing.

According to broadcasting systems of the present invention, even when the transfer rate assigned to an audio signal is limited, an audio codec signal can be broadcasted and received.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese priority application no. 2000-274456 filed on Sep. 11, 2000 is hereby incorporated by reference.

What is claimed is:

1. An audio encoder comprising:
an audio signal input section which divides inputted digital audio data for each specified time;
a filter bank which converts sample data on a time domain divided by said audio signal input section to spectral data on a frequency domain;
a quantization section which quantizes and encodes said spectral data on said frequency domain obtained from said filter bank, and outputs an audio codec signal;
a quantization controller which controls the quantizing method and the coding method to said quantization section; and
a bitstream multiplexer which converts the audio codec signal outputted from said quantization section to an audio codec stream,
wherein said quantization section comprises:
a quantizer which quantizes said spectral data according to a specified quantization format, and outputs first quantization information;
an offset value adder, when setting n-kinds of offset values for said quantization information obtained in said quantizer, which adds a k (k =1, 2, • • n)th offset value to said first quantization information, and outputs respective 2nd, 3rd, to (n+1)th quantization information;
an encoding unit which encodes said first quantization information to (n+1)th quantization information according to a specified encoding format, forms coded values of first coded value to (n+1)th coded value, posts both the code length of respective coded values and codebook names used for coding to said quantization controller, and outputs one of said coded value including a shortest code length instructed from said quantization controller as audio codec signal; and
a side information adder which extracts said offset value used for the coded value selected in said quantization controller from respective offset values added by said offset value adder, and adds both said offset value and said codebook name used for coding as side information to said audio codec signal.

2. The audio encoder according to claim 1,
wherein said quantization section calculates a code length required to code said spectral data; and
said quantization controller outputs a control signal to select a coding method on the basis of said code length.

3. The audio encoder according to claim 1,
wherein said each offset value is a predetermined fixed value.

4. The audio encoder according to claim 1,
wherein said offset value is updated at least for each the minimum coding unit or frame unit within specified units of said audio codec stream.

5. The audio encoder according to claim 1,
wherein said coding format in said quantization section is Huffman coding, and uses a Huffman codebook varying depending on said offset value.

6. The audio encoder according to claim 1,
wherein, when said offset value takes the same value as the one prior to at least one stream unit in said audio codec stream, said offset value is not added to said side information.

7. An audio decoder comprising:
a stream input section which converts an inputted audio codec stream to audio codec signal and side information;
an offset information output section which extracts offset information including offset values and codebook names from said side information;
an inverse quantization section which inputs said audio codec signal from said stream input section, decodes and inverse quantize said audio codec signal by the use of the offset value and codebook name obtained in said offset information output section, and converts said signal to spectral data on a frequency domain;
an inverse filter bank which converts said spectral data on said frequency domain obtained in said inverse quantization section to sample data on a time domain; and
an audio signal output section which sequentially combines said sample data on said time domain to output said data as audio signal,
wherein said inverse quantization section comprises:
a decoding unit which decodes said audio codec signal according to said coding format obtained in said side information, and outputs a first decoded quantization information;
an offset value remover which removes said offset value from said first decoded quantization information by the use of said offset value obtained from said offset information output section, and converts said information to a second decoded quantization information; and
an inverse quantizer which converts said second decoded quantization information outputted from said offset value remover to said spectral data on said frequency domain.

8. The audio decoder according to claim 7,
wherein said inverse quantization section includes an offset value memory for storing an offset value which is extracted in said offset information output section and is the one prior to at least one stream unit, and when an offset value has not been added to the currently inputted audio codec stream, executes inverse quantization by the use of said offset value stored on said offset value memory.

9. An audio encoder comprising:
an audio signal input section which divides inputted digital audio data for each specified time;
a filter bank which converts sample data on a time domain divided by said audio signal input section to spectral data on a frequency domain;
a quantization section which quantizes and Huffman-encodes said spectral data on said frequency domain obtained from said filter bank, and outputs an audio codec signal;
a quantization controller which controls the quantizing method and the Huffman-coding method to said quantization section; and
a bitstream multiplexer which converts the audio codec signal outputted from said quantization section to an audio codec stream,
wherein said quantization section comprises:
a quantization/first Huffman coding unit which quantizes said spectral data according to a specified quantization format to convert to quantization information, and calculates a first Huffman code index on the basis of said quantization information;
an offset value adder, when setting n-kinds of offset values for the first Huffman code index obtained in said quantization/first Huffman coding unit, which adds a k (k=1, 2, • • n)th offset value to said first Huffman code index, and outputs respective 2nd, 3rd to (n+1)th Huffman code index;
a second Huffman encoding unit which encodes said first Huffman code index to (n+1)th Huffman code index according to a specified Huffman coding format, forms first coded value to (n+1)th coded value, posts both the code length of respective coded values and codebook names used for coding to said quantization controller, and outputs an Huffman coded value having a shortest code length instructed from said quantization controller as an audio codec signal; and
a side information adder which extracts said offset value used for the coded value selected in said quantization controller from respective offset values added by said offset value adder, and adds both said offset value and said codebook name used for coding as side information to said audio codec signal.

10. An audio decoder comprising:
a stream input section which converts an inputted audio codec stream to audio codec signal and side information;
an offset information output section which extracts offset information including offset values and codebook names from said side information;
an inverse quantization section which inputs said audio codec signal from said stream input section, decodes and inverse quantizes said audio codec signal by the use of the offset value and codebook name obtained in said offset information output section, and converts said signal to spectral data on a frequency domain;
an inverse filter bank which converts said spectral data on said frequency domain obtained in said inverse quantization section to sample data on a time domain; and
an audio signal output section which sequentially combines said sample data on said time domain to output said data as audio signal,
wherein said inverse quantization section comprises:
a first Huffman decoding unit which inputs said audio codec stream to execute first Huffman decoding, and outputs a first Huffman code index;
an offset value remover which removes said offset value from said first Huffman code index by the use of said offset value obtained from said offset information output section, and outputs a second Huffman code index; and
a second Huffman decoding unit/inverse quantizer which executes second Huffman decoding by the use of the second Huffman code index outputted from said offset value remover to convert to decoded quantization information, and converts said decoded quantization information to the spectral data on said frequency domain.

11. An audio encoder comprising:
an audio signal input section which divides inputted digital audio data for each specified time;
a filter bank which converts sample data on a time domain divided by said audio signal input section to spectral data on a frequency domain;
a quantization section which quantizes and Huffman-encodes said spectral data on said frequency domain obtained from said filter bank, and outputs an audio codec signal;
a quantization controller which controls the quantizing method and the Huffman-coding method to said quantization section; and
a bitstream multiplexer which converts the audio codec signal outputted from said quantization section to an audio codec stream,
wherein said quantization section comprises:
a quantization/first Huffman coding unit which quantizes said spectral data according to a specified quantization format to convert to quantization information, and calculates a first Huffman code index on the basis of said quantization information;
a reference pattern memory which stores n-tuples of reference patterns of respective Huffman code indexes and Huffman coded values thereof;
a second Huffman encoding unit which Huffman-codes said quantization information by the use of said first reference pattern to the n-th reference pattern, forms first Huffman coded value to n-th Huffman coded value, posts both the code length of respective coded values and reference pattern numbers used for coding to said quantization controller, and outputs an Huffman coded value having a shortest code length instructed from said quantization controller as an audio codec signal; and
a side information adder which adds said reference pattern number used in said Huffman coded value selected in said quantization controller from respective reference patterns stored on said reference pattern memory to said audio codec signal as side information.

12. An audio decoder comprising:
a stream input section for converting the inputted audio codec stream to an audio codec signal and side information;
a reference pattern information output section which extracts reference pattern information including reference pattern number from said side information;
an inverse quantization section which inputs said audio codec signal from said stream input section, Huffman-decodes and inverse quantizes said audio codic signal by the use of the reference pattern number obtained in said reference pattern information output section, and converts said signal to a spectral data on a frequency domain;
an inverse filter bank which converts said spectral data on said frequency domain obtained in said inverse quantization section to sample data on a time domain; and
an audio signal output section which sequentially combines said sample data on said time domain to output the data as an audio signal,
wherein said inverse quantization section comprises:
a first Huffman decoding unit which inputs said audio codec stream to execute Huffman decoding;
a reference pattern memory/decoding unit which stores n-tuples of assignment tables for said Huffman decoded value and said index corresponding to respective reference pattern numbers, and outputs a reference pattern used for the current decoding; and
a second Huffman decoding unit/inverse quantizer which determines said index corresponding to the Huffman decoded value obtained in the said first Huffman decoding unit by using of specified reference pattern stored in said reference pattern memory/decoding unit according to said reference pattern number, and acquires the decoded quantization information from said index.

13. Broadcasting system which uses an audio codec stream generated by an audio encoder,
wherein said audio encoder comprises:
an audio signal input section which divides inputted digital audio data for each specified time;
a filter bank which converts sample data on a time domain divided by said audio signal input section to spectral data on a frequency domain;
a quantization section which quantizes and encodes said spectral data on said frequency domain obtained from said filter bank, and outputs an audio codec signal;
a quantization controller which controls the quantizing method and the coding method to said quantization section; and
a bitstream multiplexer which converts the audio codec signal outputted from said quantization section to an audio codec stream,
wherein said quantization section comprises:
a quantizer which quantizes said spectral data according to a specified quantization format, and outputs first quantization information;
an offset value adder, when setting n-kinds of offset values for said quantization information obtained in said quantizer, which adds a k (k=1, 2, • • n)th offset value to said first quantization information, and outputs respective 2nd, 3rd, to (n+1)th quantization information;
an encoding unit which encodes said first quantization information to (n+1)th quantization information according to a specified encoding format, forms coded values of first coded value to (n+1)th coded value, posts both the code length of respective coded values and codebook names used for coding to said quantization controller, and outputs one of said coded value including a shortest code length instructed from said quantization controller as audio codec signal; and
a side information adder which extracts said offset value used for the coded value selected in said quantization controller from respective offset values added by said offset value adder, and adds both said offset value and said codebook name used for coding as side information to said audio codec signal.

14. Broadcasting system which uses an audio codec stream generated by an audio encoder and audio decoder,
wherein said audio encoder comprises:
an audio signal input section which divides inputted digital audio data for each specified time;
a filter bank which converts sample data on a time domain divided by said audio signal input section to spectral data on a frequency domain;
a quantization section which quantizes and encodes said spectral data on said frequency domain obtained from said filter bank, and outputs an audio codec signal;
a quantization controller which controls the quantizing method and the coding method to said quantization section; and
a bitstream multiplexer which converts the audio codec signal outputted from said quantization section to an audio codec stream,
wherein said quantization section comprises:
a quantizer which quantizes said spectral data according to a specified quantization format, and outputs first quantization information;
an offset value adder, when setting n-kinds of offset values for said quantization information obtained in said quantizer, which adds a k (k=1, 2, • • n)th offset value to said first quantization information, and outputs respective 2nd, 3rd, to (n+1)th quantization information;
an encoding unit which encodes said first quantization information to (n+1)th quantization information according to a specified encoding format, forms coded values of first coded value to (n+1)th coded value, posts both the code length of respective coded values and codebook names used for coding to said quantization controller, and outputs one of said coded value including a shortest code length instructed from said quantization controller as audio codec signal; and
a side information adder which extracts said offset value used for the coded value selected in said quantization controller from respective offset values added by said offset value adder, and adds both said offset value and said codebook name used for coding as side information to said audio codec signal,
and said decoder comprises;
a stream input section which converts an inputted audio codec stream to audio codec signal and side information;
an offset information output section which extracts offset information including offset values and codebook names from said side information;
an inverse quantization section which inputs said audio codec signal from said stream input section, decodes and inverse quantize said audio codec signal by the use of the offset value and codebook name obtained in said offset information output section, and converts said signal to spectral data on a frequency domain;
an inverse filter bank which converts said spectral data on said frequency domain obtained in said inverse quantization section to sample data on a time domain; and
an audio signal output section which sequentially combines said sample data on said time domain to output said data as audio signal,
wherein said inverse quantization section comprises:
a decoding unit which decodes said audio codec signal according to said coding format obtained in said side information, and outputs a first decoded quantization information;
an offset value remover which removes said offset value from said first decoded quantization information by the use of said offset value obtained from said offset information output section, and converts said information to a second decoded quantization information, and
an inverse quantizer which converts said second decoded quantization information outputted from said offset value remover to said spectral data on said frequency domain.

15. Broadcasting system which uses an audio codec stream generated by an audio encoder,
wherein said audio encoder comprises:
an audio signal input section which divides inputted digital audio data for each specified time;
a filter bank which converts sample data on a time domain divided by said audio signal input section to spectral data on a frequency domain;
a quantization section which quantizes and Huffman-encodes said spectral data on said frequency domain obtained from said filter bank, and outputs an audio codec signal;
a quantization controller which controls the quantizing method and the Huffman-coding method to said quantization section; and
a bitstream multiplexer which converts the audio codec signal outputted from said quantization section to an audio codec stream,
wherein said quantization section comprises:
a quantization/first Huffman coding unit which quantizes said spectral data according to a specified quantization format to convert to quantization information, and calculates a first Huffman code index on the basis of said quantization information;
an offset value adder, when setting n-kinds of offset values for the first Huffman code index obtained in said quantization/first Huffman coding unit, which adds a k (k=1, 2, • • n)th offset value to said first Huffman code index, and outputs respective 2nd, 3rd to (n+1)th Huffman code index;
a second Huffman encoding unit which encodes said first Huffman code index to (n+1)th Huffman code index according to a specified Huffman coding format, forms first coded value to (n+1)th coded value, posts both the code length of respective coded values and codebook names used for coding to said quantization controller, and outputs an Huffman coded value having a shortest code length instructed from said quantization controller as an audio codec signal; and
a side information adder which extracts said offset value used for the coded value selected in said quantization controller from respective offset values added by said offset value adder, and adds both said offset value and said codebook name used for coding as side information to said audio codec signal.

16. Broadcasting system which uses an audio codec stream generated by an audio encoder and audio decoder,
wherein said audio encoder comprises:
an audio signal input section which divides inputted digital audio data for each specified time;
a filter bank which converts sample data on a time domain divided by said audio signal input section to spectral data on a frequency domain;
a quantization section which quantizes and Huffman-encodes said spectral data on said frequency domain obtained from said filter bank, and outputs an audio codec signal;
a quantization controller which controls the quantizing method and the Huffman-coding method to said quantization section; and
a bitstream multiplexer which converts the audio codec signal outputted from said quantization section to an audio codec stream,
wherein said quantization section comprises:
a quantization/first Huffman coding unit which quantizes said spectral data according to a specified quantization format to convert to quantization information, and calculates a first Huffman code index on the basis of said quantization information;
an offset value adder, when setting n-kinds of offset values for the first Huffman code index obtained in said quantization/first Huffman coding unit, which adds a k (k=1, 2, • • n)th offset value to said first Huffman code index, and outputs respective 2nd, 3rd to (n+1)th Huffman code index;
a second Huffman encoding unit which encodes said first Huffman code index to (n+1)th Huffman code index according to a specified Huffman coding format, forms first coded value to (n+1)th coded value, posts both the code length of respective coded values and codebook names used for coding to said quantization controller, and outputs an Huffman coded value having a shortest code length instructed from said quantization controller as an audio codec signal; and
a side information adder which extracts said offset value used for the coded value selected in said quantization controller from respective offset values added by said offset value adder, and adds both said offset value and said codebook name used for coding as side information to said audio codec signal,
and said audio decoder comprises:
a stream input section which converts an inputted audio codec stream to audio codec signal and side information;
an offset information output section which extracts offset information including offset values and codebook names from said side information;
an inverse quantization section which inputs said audio codec signal from said stream input section, decodes and inverse quantizes said audio codec signal by the use of the offset value and codebook name obtained in said offset information output section, and converts said signal to spectral data on a frequency domain;
an inverse filter bank which converts said spectral data on said frequency domain obtained in said inverse quantization section to sample data on a time domain; and
an audio signal output section which sequentially combines said sample data on said time domain to output said data as audio signal,
wherein said inverse quantization section comprises:
a first Huffman decoding unit which inputs said audio codec stream to execute first Huffman decoding, and outputs a first Huffman code index;
an offset value remover which removes said offset value from said first Huffman code index by the use of said offset value obtained from said offset information output section, and outputs a second Huffman code index; and
a second Huffman decoding unit/inverse quantizer which executes second Huffman decoding by the use of the second Huffman code index outputted from said offset value remover to convert to decoded quantization information, and converts said decoded quantization information to the spectral data on said frequency domain.

17. Broadcasting system which uses an audio codec stream generated by an audio encoder,
wherein said audio encoder comprises:
an audio signal input section which divides inputted digital audio data for each specified time;
a filter bank which converts sample data on a time domain divided by said audio signal input section to spectral data on a frequency domain;
a quantization section which quantizes and Huffman-encodes said spectral data on said frequency domain obtained from said filter bank, and outputs an audio codec signal;
a quantization controller which controls the quantizing method and the Huffman-coding method to said quantization section; and
a bitstream multiplexer which converts the audio codec signal outputted from said quantization section to an audio codec stream,
wherein said quantization section comprises:
a quantization/first Huffman coding unit which quantizes said spectral data according to a specified quantization format to convert to quantization information, and calculates a first Huffman code index on the basis of said quantization information;
a reference pattern memory which stores n-tuples of reference patterns of respective Huffman code indexes and Huffman coded values thereof;
a second Huffman encoding unit which Huffman-codes said quantization information by the use of said first reference pattern to the n-th reference pattern, forms first Huffman coded value to n-th Huffman coded value, posts both the code length of respective coded values and reference pattern numbers used for coding to said quantization controller, and outputs an Huffman coded value having a shortest code length instructed from said quantization controller as an audio codec signal; and
a side information adder which adds said reference pattern number used in said Huffman coded value selected in said quantization controller from respective reference patterns stored on said reference pattern memory to said audio codec signal as side information.

18. Broadcasting system which uses an audio codec stream generated by an audio encoder and audio decoder,
wherein said audio encoder comprises:
an audio signal input section which divides inputted digital audio data for each specified time;
a filter bank which converts sample data on a time domain divided by said audio signal input section to spectral data on a frequency domain;
a quantization section which quantizes and Huffman-encodes said spectral data on said frequency domain obtained from said filter bank, and outputs an audio codec signal;
a quantization controller which controls the quantizing method and the Huffman-coding method to said quantization section; and
a bitstream multiplexer which converts the audio codec signal outputted from said quantization section to an audio codec stream,
wherein said quantization section comprises:
a quantization/first Huffman coding unit which quantizes said spectral data according to a specified quantization format to convert to quantization information, and calculates a first Huffman code index on the basis of said quantization information;
a reference pattern memory which stores n-tuples of reference patterns of respective Huffman code indexes and Huffman coded values thereof;
a second Huffman encoding unit which Huffman-codes said quantization information by the use of said first reference pattern to the n-th reference pattern, forms first Huffman coded value to n-th Huffman coded value, posts both the code length of respective coded values and reference pattern numbers used for coding to said quantization controller, and outputs an Huffman coded value having a shortest code length instructed from said quantization controller as an audio codec signal; and
a side information adder which adds said reference pattern number used in said Huffman coded value selected in said quantization controller from respective reference patterns stored on said reference pattern memory to said audio codec signal as side information,
and said decoder comprises:
a stream input section for converting the inputted audio codec stream to an audio codec signal and side information,
a reference pattern information output section which extracts reference pattern information including reference pattern number from said side information;
an inverse quantization section which inputs said audio codec signal from said stream input section, Huffman-decodes and inverse quantizes said audio codic signal by the use of the reference pattern number obtained in said reference pattern information output section, and converts said signal to a spectral data on a frequency domain;
an inverse filter bank which converts said spectral data on said frequency domain obtained in said inverse quantization section to sample data on a time domain; and
an audio signal output section which sequentially combines said sample data on said time domain to output the data as an audio signal,
wherein said inverse quantization section comprises:
a first Huffman decoding unit which inputs said audio codec stream to execute Huffman decoding;
a reference pattern memory/decoding unit which stores n-tuples of assignment tables for said Huffman decoded value and said index corresponding to respective reference pattern numbers, and outputs a reference pattern used for the current decoding; and
a second Huffman decoding unit/inverse quantizer which determines said index corresponding to the Huffman decoded value obtained in the said first Huffman decoding unit by using of specified reference pattern stored in said reference pattern memory/decoding unit according to said reference pattern number, and acquires the decoded quantization information from said index.

19. An encoding processing program comprising:
an audio signal input step for slicing inputted digital audio data for each specified time;
a filter bank processing step for converting sample data on a time domain divided by said audio signal input step to spectral data on a frequency domain;
a quantization processing step for which quantizing and encoding said spectral data on said frequency domain obtained from said filter bank processing step, and outputting an audio codec signal;
a control processing step for controlling the quantizing method and the coding method to said quantization processing step; and
a bitstream multiplex processing step for converting the audio codec signal outputted from said quantization processing step to an audio codec stream,
wherein said quantization processing step comprises:
a quantizing step for quantizing said spectral data according to a specified quantization format, and outputting first quantization information;
an offset value adding step, when setting n-kinds of offset values for said quantization information obtained in said quantizing step, adding a k (k =1, 2, • • n)th offset value to said first quantization information, and outputting respective 2nd, 3rd, to (n+1)th quantization information;
an encoding step for coding said first quantization information to (n+1)th quantization information according to a specified encoding format, forming first coded value to (n+1)th coded value, posting both the code length of respective coded values and codebook names used for coding to said control processing step, and outputting one of said coded value including a shortest code length instructed from said control processing step as audio codec signal; and
a side information adding step for extracting sn offset value used for the coded value selected in said control processing step from respective offset values added by said offset value adding step, and adding both said offset value and said codebook name used for coding as side information to said audio codec signal.

20. An audio decoding processing program comprising:
a stream input step for converting an inputted audio codec stream to audio codec signal and side information;
an offset information output processing step for extracting offset information including offset values and codebook names from said side information;
an inverse quantization section which inputting said audio codec signal from said stream input step, decodeing and inverse quantizing said audio codec signal by the use of the offset value and codebook name obtained in said offset information output processing step, and converting said signal to spectral data on a frequency domain;
an inverse filter bank processing step for converting said spectral data on said frequency domain obtained in said inverse quantization processing step to sample data on a time domain; and
an audio signal output processing step sequentially combining said sample data on said time domain to output said data as audio signal,
wherein said inverse quantization processing step comprises:
a decoding step for decoding said audio codec signal according to said coding format obtained in said side information, and outputting a first decoded quantization information;
an offset value removing step for removing said offset value from said first decoded quantization information by the use of said offset value obtained from said offset information output processing step, and converting said information to a second decoded quantization information; and
an inverse quantizing step for which converting said second decoded quantization information outputted from said offset value removing step to said spectral data on said frequency domain.

21. The recording media for recording an encoding processing program as set forth in claim 19 so that the program is operable in a computer.

22. The recording media for recording a decoding processing program as set forth in claim 20 so that the program is operable in a computer.

23. An encoding processing program comprising:
an audio signal input step f or slicing inputted digital audio data for each specified time;
a filter bank processing step for converting sample data on a time domain divided by said audio signal input step to spectral data on a frequency domain;
a quantization processing step for which quantizing and Huffman-encoding said spectral data on said frequency domain obtained from said filter bank processing step, and outputting an audio codec signal;
a control processing step for controlling the quantizing method and the Huffman-coding method to said quantization processing step; and
a bitstream multiplex processing step for converting the audio codec signal outputted from said quantization processing step to an audio codec stream,
wherein said quantization processing step comprises:
a quantization/first Huffman coding step for quantizing said spectral data according to a specified quantization format to convert to quantization information, and calculating a first Huffman code index on the basis of said quantization information;
an offset value adding step, when setting n-kinds of offset values for the first Huffman code index obtained in said quantization/first Huffman coding unit, for adding a k (k=1, 2, • • n)th offset value to said first Huffman code index, and outputting respective 2nd, 3rd to (n+1)th Huffman code index;
a second Huffman encoding step for encoding said first Huffman code index to (n+1)th Huffman code index according to a specified Huffman coding format, forming first coded value to (n+1)th coded value, posting both the code length of respective coded values and codebook names used for coding to said control processing step, and outputting an Huffman coded value having a shortest code length instructed from said control processing step as an audio codec signal; and
a side information adding step for extracting said offset value used for the coded value selected in said control processing step from respective offset values added by said offset value adding step, and adds both said offset value and said codebook name used for coding as side information to said audio codec signal.

24. An audio decoding processing program comprising:
a stream input step for converting an inputted audio codec stream to audio codec signal and side information;
an offset information output processing step for extracting offset information including offset values and codebook names from said side information;
an inverse quantization section step for inputting said audio codec signal from said stream input step, Huffman-decodeing and inverse quantizing said audio codec signal by the use of the offset value and codebook name obtained in said offset information output processing step, and converting said signal to spectral data on a frequency domain;
an inverse filter bank processing step for converting said spectral data on said frequency domain obtained in said inverse quantization processing step to sample data on a time domain; and
an audio signal output processing step sequentially combining said sample data on said time domain to output said data as audio signal,
wherein said inverse quantization processing step comprises:
a first Huffman decoding step for inputting said audio codec stream to execute first Huffman decoding, and outputting a first Huffman code index;
an offset value removing step for removing said offset value from said first Huffman code index by the use of said offset value obtained from said offset information output processing step, and outputting a second Huffman code index; and
a second Huffman decoding unit/inverse quantizing step for executing second Huffman decoding by the use of the second Huffman code index outputted from said offset value removing step to convert to decoded quantization information, and converting said decoded quantization information to the spectral data on said frequency domain.

25. The recording media for recording an encoding processing program as set forth in claim 23 so that the program is operable in a computer.

26. The recording media for recording a decoding processing program as set forth in claim 24 so that the program is operable in a computer.

27. An encoding processing program comprising:
an audio signal input step for slicing inputted digital audio data for each specified time;
a filter bank processing step for converting sample data on a time domain divided by said audio signal input step to spectral data on a frequency domain;
a quantization processing step for which quantizing and Huffman-encoding said spectral data on said frequency domain obtained from said filter bank processing step, and outputting an audio codec signal;
a control processing step for controlling the quantizing method and the Huffman-coding method to said quantization processing step; and
a bitstream multiplex processing step for converting the audio codec signal outputted from said quantization processing step to an audio codec stream,
wherein said quantization processing step comprises:
a quantization/first Huffman coding step for quantizing said spectral data according to a specified quantization format to convert to quantization information, and calculating a first Huffman code index on the basis of said quantization information;
a reference pattern storing step for storing n-tuples of reference patterns of respective Huffman code indexes and Huffman coded values thereof;
a second Huffman encoding step for Huffman-coding said quantization information by the use of said first reference pattern to the n-th reference pattern, forming first Huffman coded value to n-th Huffman coded value, posting both the code length of respective coded values and reference pattern numbers used for coding to said quantization control processing step, and outputting an Huffman coded value having a shortest code length instructed from said controlling step as an audio codec signal; and
a side information adding step for adding said reference pattern number used in said Huffman coded value selected in said quantization control processing step from respective reference patterns stored on said reference pattern memory to said audio codec signal as side information.

28. An audio decoding processing program comprising:
a stream input step for converting an inputted audio codec stream to audio codec signal and side information;
a reference pattern information output processing step for extracting reference pattern information including reference pattern number from said side information;
an inverse quantization section step for inputting said audio codec signal from said stream input step, Huffman-decodeing and inverse quantizing said audio codec signal by the use of reference pattern number obtained in said offset information output processing step, and converting said signal to spectral data on a frequency domain;
an inverse filter bank processing step for converting said spectral data on said frequency domain obtained in said inverse quantization processing step to sample data on a time domain; and
an audio signal output processing step sequentially combining said sample data on said time domain to output said data as audio signal,
wherein said inverse quantization processing step comprises:
a first Huffman decoding step for inputting said audio codec stream to execute Huffman decoding;
a reference pattern memory/decoding step for storing n-tuples of assignment tables for said Huffman decoded value and said index corresponding to respective reference pattern numbers, and outputting a reference pattern used for the current decoding; and
a second Huffman decoding unit/inverse quantizing step for determining said index corresponding to the Huffman decoded value obtained in the said first Huffman decoding step by using of specified reference pattern stored in said reference pattern memory/decoding step according to said reference pattern number, and acquiring the decoded quantization information from said index.

29. The recording media for recording an encoding processing program as set forth in claim 27 so that the program is operable in a computer.

30. The recording media for recording a decoding processing program as set forth in claim 28 so that the program is operable in a computer.
